(19) United States
(12) Patent Application Publication
(10) Pub. No.: US 2012/0028855 A1
(43) Pub. Date: Feb. 2, 2012

(54) SHALE HYDRATION INHIBITION AGENT(S) AND METHOD OF USE

(75) Inventor: Richard F. MILLER, Humble, TX (US)

(73) Assignee: SHRIEVE CHEMICAL PRODUCTS, The Woodlands, TX (US)

(21) Appl. No.: 13/210,149

(22) Filed: Aug. 15, 2011

Related U.S. Application Data
(63) Continuation-in-part of application No. 12/411,709, filed on Mar. 26, 2009, now Pat. No. 8,026,198.
Application No. 12/411,709 is a continuation-in-part of application No. 12/410,662, filed on Mar. 25, 2009, now Pat. No. 8,022,014.
(60) Provisional application No. 61/039,673, filed on Mar. 26, 2008.
(60) Provisional application No. 61/103,471, filed on Oct. 7, 2008.
(60) Provisional application No. 61/103,450, filed on Oct. 7, 2008.
(60) Provisional application No. 61/039,669, filed on Mar. 26, 2008.

(51) Int. Cl. C09K 8/04

(52) U.S. Cl. 507/129

(57) ABSTRACT

A method of using water-based drilling fluid in a subterranean formation containing shale which swells in the presence of water by circulating a water-based drilling fluid into the formation. The drilling fluid is made of an aqueous based continuous phase, a weighting material, and a shale hydration inhibition agent (SHIA) comprising deep eutectic solvents (DES) formed by the reaction of a first compound comprising an ammonium compound, and a second compound comprising at least one of amides, amines, diamines, cyclic amines, cyclic diamines, and combinations thereof. The SHIA is present in an amount sufficient to reduce shale swelling. A method of reducing shale swelling during wellbore drilling that includes providing a water-based drilling fluid comprising an aqueous based continuous phase, a weighting material, and a SHIA comprising DES formed by the reaction of a quaternary ammonium compound, and a diamine; and circulating the drilling fluid into the subterranean formation.

### CROSS-REFERENCE TO RELATED APPLICATIONS

This application is a continuation-in-part of U.S. patent application Ser. No. 12/411,709, filed Mar. 26, 2009, which claims the benefit under 35 U.S.C. §119(e) of U.S. Provisional Patent Application No. 61/039,673, filed on Mar. 26, 2008; provisional application 61/103,471, filed on Oct. 7, 2008; and provisional application 61/103,450, filed on Oct. 7, 2008. This application is also a continuation-in-part of U.S. application Ser. No. 12/410,662, filed Mar. 25, 2009, which claims the benefit under 35 U.S.C. §119(e) of U.S. Provisional Patent Application Ser. No. 61/039,669, filed Mar. 26, 2008. The disclosures of each of the aforementioned applications are hereby incorporated herein by reference.

### BACKGROUND

1. Field of the Invention

The present invention relates generally to drilling fluid compositions and their use. More specifically, the present invention relates to shale hydration inhibition agents in a drilling fluid composition and method of using same.

This invention relates generally to the field of subterranean drilling and material recovery. More specifically, this invention relates to the use of deep eutectic solvents and/or solutions to solubilize cellulose or modified cellulosic polymers used in subterranean drilling and fracturing operations. The present invention also relates to a deep eutectic solvent used to inhibit shale hydration in a subterranean formation.

2. Background of the Invention

In rotary drilling of subterranean wells numerous functions and characteristics are expected of a drilling fluid. A drilling fluid should circulate throughout the well, carrying cuttings from beneath the bit, transporting the cuttings up the annulus, and allowing their separation at the surface. At the same time, the drilling fluid is expected to cool and clean the drill bit, reduce friction between the drill string and the sides of the hole, and maintain stability in the borehole's uncased sections. The drilling fluid should also form a thin, low permeability filter cake that seals openings in formations penetrated by the bit and acts to reduce the unwanted influx of formation fluids from permeable rocks.

Drilling fluids are typically classified according to their base material. In oil base fluids, solid particles are suspended in oil, and water or brine may be emulsified with the oil. The oil is typically the continuous phase. In water base fluids, solid particles are suspended in water or brine, and oil may be emulsified in the water. The water is typically the continuous phase. Pneumatic fluids are a third class of drilling fluids in which a high velocity stream of air or natural gas removes drill cuttings.

Three types of solids are usually found in water base drilling fluids: 1) clays and organic colloids added to provide necessary viscosity and filtration properties; 2) heavy minerals whose function is to increase the drilling fluid's density; and 3) formation solids that become dispersed in the drilling fluid during the drilling operation.

The formation solids that become dispersed in a drilling fluid are typically the cuttings produced by the drill bit's action and the solids produced by borehole instability. Where the formation solids are clay minerals that swell, the presence of either type of formation solids in the drilling fluid can greatly increase drilling time and costs.

Clay minerals are generally crystalline in nature. The structures of the crystals in clay determine many properties thereof. Typically, clays have a flaky, mica-type structure. Clay flakes are made up of a number of crystal platelets stacked face-to-face. Each platelet is called a unit layer, and the surfaces of the unit layer are called basal surfaces. A unit layer is composed of multiple sheets. One sheet is called the octahedral sheet, it is composed of either aluminum or magnesium atoms octahedrally coordinated with the oxygen atoms of hydroxyls. Another sheet is called the tetrahedral sheet. The tetrahedral sheet consists of silicon atoms tetrahedrally coordinated with oxygen atoms. Sheets within a unit layer link together by sharing oxygen atoms. When this linking occurs between one octahedral and one tetrahedral sheet, one basal surface consists of exposed oxygen atoms while the other basal surface has exposed hydroxyls. It is also quite common for two tetrahedral sheets to bond with one octahedral sheet by sharing oxygen atoms. The resulting structure, known as the Hoffman structure, has an octahedral sheet that is sandwiched between the two tetrahedral sheets. As a result, both basal surfaces in a Hoffman structure are composed of exposed oxygen atoms.

The unit layers stack together face-to-face and are held in place by weak attractive forces. The distance between corresponding planes in adjacent unit layers is called the c-spacing. A clay crystal structure with a unit layer consisting of three sheets typically has a c-spacing of about 9.5×10⁻⁷ mm.

In clay mineral crystals, atoms having different valences commonly will be positioned within the sheets of the structure to create a negative potential at the crystal surface. In that case, a cation is adsorbed on the surface. These adsorbed cations are called exchangeable cations because they may chemically trade places with other cations when the clay crystal is suspended in water. In addition, ions may also be adsorbed on the clay crystal edges and exchange with other ions in the water.

The type of substitutions occurring within the clay crystal structure and the exchangeable cations adsorbed on the crystal surface greatly affect clay swelling, a property of primary importance in the drilling fluid industry. Clay swelling is a phenomenon in which water molecules surround a clay crystal structure and position themselves to increase the structure's c-spacing thus resulting in an increase in volume. Two types of swelling may occur.

Surface hydration is one type of swelling in which water molecules are adsorbed on crystal surfaces. Hydrogen bonding holds a layer of water molecules to the oxygen atoms exposed on the crystal surfaces. Subsequent layers of water molecules align to form a quasi-crystalline structure between unit layers which results in an increased c-spacing. All types of clays swell in this manner.

Osmotic swelling is a second type of swelling. Where the concentration of cations between unit layers in a clay mineral is higher than the cation concentration in the surrounding water, water is osmotically drawn between the unit layers and the c-spacing is increased. Osmotic swelling results in larger overall volume increases than surface hydration. However, only certain clays, like sodium montmorillonite, swell in this manner.

Exchangeable cations found in clay minerals are reported to have a significant impact on the amount of swelling that takes place. The exchangeable cations compete with water molecules for the available reactive sites in the clay structure. Generally cations with high valences are more strongly adsorbed than ones with low valences. Thus, clays with low valence exchangeable cations will swell more than clays whose exchangeable cations have high valences.

In the North Sea and the United States Gulf Coast, drillers commonly encounter argillaceous sediments in which the predominant clay mineral is sodium montmorillonite (commonly called “gumbo shale”). Sodium cations are predominately the exchangeable cations in gumbo shale. As the sodium cation has a low positive valence (i.e. formally a +1 valence), it easily disperses into water. Consequently, gumbo shale is notorious for its swelling.

Clay swelling during the drilling of a subterranean well can have a tremendous adverse impact on drilling operations. The overall increase in bulk volume accompanying clay swelling impedes removal of cuttings from beneath the drill bit, increases friction between the drill string and the sides of the borehole, and inhibits formation of the thin filter cake that seals formations. Clay swelling can also create other drilling problems such as loss of circulation or stuck pipe that slow drilling and increase drilling costs.

Cellulose is one of the most abundant bio-renewable materials with a long and well-established technological base. Cellulose consists of poly-disperse linear glucose polymer chains which form extremely strong hydrogen-bonded supra-molecular structures making cellulose insoluble in water and most common organic liquids. Chemically-modified cellulose is significantly more soluble in water and imparts viscous properties to solutions making it useful as an ingredient in drilling and/or fracturing fluid useful in subterranean drilling operations. In the particular case of fracturing a formation, causing cracks to form in the subterranean strata, to allow for the production of hydrocarbon components with substantially greater ease, it is often necessary to clean the well bore and resulting fractures to remove cellulosic material that may have become deposited during the aforementioned operations and which will impede flow of hydrocarbons through the fractures and/or production.

As previously mentioned, cellulose is insoluble in water and most common organic solvents. Where chemically-modified cellulose is employed, it is not atypical for all or part of the material to be hydrolyzed under use conditions reforming the parent compound, cellulose, which will again become insoluble. Thus, given the frequency with which cellulosic material is employed in drilling and fracturing subterranean wells, the development of an additive and/or solvent for solubilizing cellulose and/or chemically-modified cellulosic material remains a continuing challenge in the oil and gas exploration industry.

In the prior art, room temperature ionic liquids (RTIL) can solubilize up to 15 wt % cellulose with heating to 150° F. employing preferably microwave heating. According to Swatlowski, et al. (U.S. Pat. No. 6,824,599), a solution of cellulose in an ionic liquid can contain cellulose in an amount of about 5 to about 35 weight percent; more preferably, the cellulose is present at about 5 to 25 weight percent, still more preferably from about 10 to about 25 weight percent. According to Swatlowski, this solubility of cellulose in a RTIL, such as [C4mim] Cl⁻, is significantly higher than can be obtained using other solvents.

Consequently, there is a need for a method of removing cellulose and/or cellulosic compounds from a subterranean region. The method may prevent/minimize the deposition of cellulose and/or cellulosic compounds on or in the subterranean region or may solubilize deposited cellulose/cellulosic compounds deposited in a subterranean region, allowing removal thereof. Desirably, the method will allow better cost performance and/or improved toxicological and/or handling properties relative to RTILs, many of which react adversely with water.

There is a continuing need for the development of a drilling fluid composition and method of using same to reduce clay swelling in the oil and gas exploration industry.

### SUMMARY

In some embodiments of this disclosure, a water-based drilling fluid is presented, which is used in drilling wells through a formation containing shale that swells in the presence of water. The drilling fluid comprises an aqueous based continuous phase; a weighting material; and a shale hydration inhibition agent (SHIA) selected from the group consisting of

(a) propylamine derivatives having the formula R—Y—(CH₂)ₙ—NH₂, wherein n=3; Y═O or N; R=ne or more —CH₃ groups or a morpholino-group;

(b) hydrogenated poly(propyleneimine) dendrimers (HPPID) having a core with the formula N(-A-N*)₃ and branches with the formula —(H)₃ or -(AN*H₂)₃ wherein A=(CH₂)₃ and N* is the growth point where two additional branches are attached; (c) polyamine twin dendrimers (PTD) having a core with the formula H₂N —(CH₂)ₓ—NH₂, wherein 2≦x≦6, and branches B with the formula —(CH₂—CH₂—CH₂—NH₂), wherein the core and the branches are arranged as:

(B)₂ⁿ . . . —(B)₈—(B)⁴—(B)₂—[H₂N—(CH₂)ₓ—NH₂]—(B)₂—(B)₄—(B)₈— . . . (B)₂ⁿ

wherein n is the dendrimer growth generation number and n<10. The SHIA of this disclosure is present in an amount that is sufficient to reduce shale swelling.

In an embodiment, a propylamine derivative of this disclosure is 3-methoxypropylamine (MOPA), having the formula CH₃—O—(CH₂)₃—NH₂. In an embodiment, a propylamine derivative of this disclosure is dimethylaminopropylamine (DMAPA), having the formula (CH₃)₂—N —(CH₂)₃—NH₂. In an embodiment, a propylamine derivative of this disclosure is N-aminopropylmorpholine (APM), having the formula:

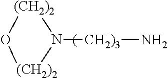

In an embodiment, a HPPID of this disclosure is a first generation HPPID having the formula N-(A-NH₂)₃, wherein A=(CH₂)₃. In an embodiment, a HPPID of this disclosure is a second generation HPPID having the formula N-[A-N(A-NH₂)₂]₃, wherein A=(CH₂)₃. In an embodiment, a HPPID of this disclosure is a third generation HPPID having the formula N-{A-N-[A-N(A-NH₂)₂]₂}₃, wherein A=(CH₂)₃. In some embodiments, the HPPIDs of this disclosure have a molecular weight of from about 150 to about 5800.

In an embodiment, the core of a PTD of this disclosure is selected from the group consisting of ethylene diamine, propylene diamine, and hexamethylene. In an embodiment, a PTD of this disclosure has a molecular weight of from about 250 to about 7500.

In some embodiments, the SHIA of this disclosure is not hydrolyzed at a temperature in the range of from about 100° F. to about 500° F.

In embodiments, the aqueous based continuous phase of the drilling fluid is selected from the group consisting of fresh water, sea water, brine, mixtures of water and water soluble organic compounds, and combinations thereof. In embodiments, the weighting material of the drilling fluid is selected from the group consisting of barite, hematite, iron oxide, calcium carbonate, magnesium carbonate, organic and inorganic salts, and combinations thereof. In an embodiment, the drilling fluid further comprises a fluid loss control agent. In an embodiment, the drilling fluid further comprises an encapsulating agent, selected from the group consisting of synthetic materials, organic materials, inorganic materials, bio-polymers, and combinations thereof.

In some embodiments of this disclosure, a method of reducing shale swelling encountered during the drilling of a subterranean well is described. The method comprises circulating in the subterranean well a water-based drilling fluid comprising an aqueous based continuous phase, a weighting material, and a SHIA selected from the group consisting of

(a) propylamine derivatives having the formula R—Y—(CH₂)ₙ—NH₂, wherein n=3; Y═O or N; R=one or more —CH₃ groups or a morpholino group.

(b) hydrogenated poly(propyleneimine) dendrimers (HPPID) having a core with the formula N(-A-N*)₃ and branches with the formula (—H)₃ or -(AN*H₂)₃, wherein A=(CH₂)₃ and N* is the growth point where two additional branches are attached; and

(c) polyamine twin dendrimers (PTD) having a core with the formula H₂N —(CH₂)ₓ—NH₂, wherein 2≦x≦6, and branches B with the formula —(CH₂—CH₂—CH₂—NH₂), wherein the core and the branches are arranged as:

(B)₂ⁿ . . . —(B)₈—(B)₄—(B)₂—[H₂N —(CH₂)ₓ—NH₂]—(B)₂—(B)₄—(B)₈— . . . (B)₂ⁿ

wherein n is the dendrimer growth generation number and n<10. The SHIA of this disclosure is present in an amount that is sufficient to reduce shale swelling.

In some embodiments, prior to introducing SHIA to a drilling fluid, the pH of the drilling fluid is adjusted to be in the range of from about 6.5 to about 13.0.

A method of treating a subterranean region, the method comprising: providing a eutectic solvent; and introducing the eutectic solvent into the subterranean region. In embodiments, providing a eutectic solvent further comprises reacting an ammonium compound with a second compound selected from the group consisting of amines, amides, carboxylic acids, alcohols, metal halides, and combinations thereof. In embodiments, the ammonium compound is a quaternary ammonium compound. The quaternary ammonium compound can be selected from quaternary ammonium halides. The quaternary ammonium compound can be selected from quaternary ammonium chlorides.

In embodiments, the ammonium compound is selected from the group consisting of compounds having the structures: R₁R₂R₃—N R₄Cl and Cl R₁R₂R₃—N R₄Cl, wherein R₁, R₂, and R₃ are selected from the group consisting of hydrogen and linear or branched alkyl, aryl, or alkylaryl groups CₓH_{y}, where 1≦x≦18 and 3≦y≦37, and R₄ is selected from the group consisting of hydrogen and groups having the structure CₓH_{y} or CₓH_{y}OH, where 1≦x≦18 and 3≦y≦37. In embodiments, R₁, R₂, R₃, and R₄ are each selected from the group consisting of hydrogen, methyl-, ethyl-, octadecyl-, phenyl, benzyl, methoxy-, and ethoxy-groups. In embodiments, the ammonium compound is ammonium chloride. In embodiments, the ammonium compound is a quaternary ammonium chloride, wherein none of R₁, R₂, R₃, and R₄ is hydrogen. In embodiments, the ammonium compound is selected from the group consisting of chlorcholine chloride and choline chloride.

The second compound may have a chain length (C_{length}) of 1≦C_{length}≦18. In embodiments, the second compound is urea, H₂N—CO—NH₂. In embodiments, the second compound is an amine or di-functional amine selected from the group consisting of compounds with the structure: R₁—(CH₂)ₓ—R₂, wherein 2≦x≦6, and R₁ and R₂ are selected from the group consisting of H, —NH₂, —NHR₃, and —NR₃R₄, where R₃ and R₄ are selected from alkyl, aryl, and alkylaryl groups. In embodiments, a di-functional amine is ethylene diamine, H₂N—(CH₂)₂—NH₂.

Also disclosed is a method of treating a subterranean region, the method comprising: providing an ammonium halide; reacting the ammonium halide with a hydrogen bond donor to provide a deep eutectic solvent; and introducing the deep eutectic solvent into a subterranean region. In embodiments, the subterranean region was previously treated with a drilling fluid or a fracturing fluid comprising cellulosic material. In embodiments, the deep eutectic solvent is capable of solubilizing up to 30 wt % cellulosic material. In embodiments, the deep eutectic solvent is introduced into the subterranean region as an additive in a fracturing or other drilling fluid.

In embodiments, the ammonium halide is selected from the group consisting of quaternary ammonium chlorides. The ammonium halide may be selected from the group consisting of chlorcholine chloride, choline chloride, ammonium chloride, and combinations thereof. In embodiments, the hydrogen bond donor is selected from amides, carboxylic acids, alcohols and metal halides. In embodiments, the hydrogen bond donor is selected from amides. The hydrogen bond donor may be selected from the group consisting of urea, 1-methyl urea, dimethyl urea, thiourea, acetamide, and combinations thereof. In embodiments, the hydrogen bond donor is urea.

In embodiments, the method further comprises introducing one or more wash solution into the subterranean following introducing the deep eutectic solvent into a subterranean region. The one or more wash solution can be selected from the group consisting of caustic solutions, acid solutions, anhydride solutions, water, and combinations thereof. In embodiments, more than one wash solution is introduced into the subterranean region in series.

Also disclosed is a method of treating a subterranean region for removal of cellulosic material therein or minimization/prevention of deposition of cellulosic material therein, the method comprising: reacting a quaternary ammonium chloride selected from the group consisting of chlorcholine chloride and choline chloride with a hydrogen bond donor selected from the group consisting of amides, carboxylic acids, alcohols and metal halides to produce a deep eutectic solvent; and introducing the deep eutectic solvent into the subterranean region, whereby cellulosic material is solubilized in the deep eutectic solvent. In embodiments, the deep eutectic solvent is introduced into the subterranean region as an additive to a fracturing fluid comprising cellulosic material. In embodiments, the subterranean region was treated with a fracturing fluid or drilling fluid comprising cellulosic material prior to introducing the deep eutectic solvent therein. In embodiments, the quaternary ammonium chloride is chlorcholine chloride and the hydrogen bond donor is urea. In embodiments, the quaternary ammonium chloride is choline chloride and the hydrogen bond donor is urea. Reacting may comprise combining the quaternary ammonium chloride and the hydrogen bond donor, and heating the mixture to a temperature of not greater than 100° C. thereby forming a eutectic compound.

Embodiments of this disclosure may provide for a method of using water-based drilling fluid in a subterranean formation containing a shale which swells in the presence of water that includes providing the water-based drilling fluid, and circulating the drilling fluid into the subterranean formation. The drilling fluid may include an aqueous based continuous phase, a weighting material, and a shale hydration inhibition agent (SHIA). The SHIA may be a deep eutectic solvent formed by the reaction of (a) a first compound comprising an ammonium compound, and (b) a second compound comprising at least one of, amines, diamines, cyclic amines, cyclic diamines, and combinations thereof. The SHIA may be present in a sufficient amount to reduce shale swelling.

The drilling fluid may also include at least one of a fluid loss control agent, an encapsulation additive, a corrosion inhibitor, and combinations thereof. The aqueous based continuous phase is selected from the group consisting of fresh water, sea water, brine, mixtures of water and water soluble organic compounds, and combinations thereof, and the weighting material is selected from the group consisting of barite, hematite, iron oxide, calcium carbonate, magnesium carbonate, organic and inorganic salts, and combinations thereof.

In some embodiments the ammonium compound may be a quaternary ammonium compound. In further embodiments, the quaternary ammonium compound may be at least one of choline chloride, chlorcholine chloride, and combinations thereof. The second compound may consist of diamines having a chain length (C_{length}) of 2≦C_{length}≦6. The diamine may be ethylene diamine, H₂N—(CH₂)₂—NH₂.

In embodiments, the DES may be reacted with at least one of a group selected from mineral acids, lower organic acids, and lower organic diacids, whereby the DES may be used to provide a sustained-release formulation to react with downhole scale that includes at least one of calcium, barium, and combinations thereof.

In other embodiments of this disclosure, a method of reducing shale swelling encountered during the drilling of a subterranean well is described. The method may include providing a water-based drilling fluid comprising an aqueous based continuous phase, a weighting material, and a SHIA made of a deep eutectic solvent (DES) formed by the reaction of: (a) a quaternary ammonium compound, and (b) a second compound comprising at least one of, amines, diamines, cyclic amines, cyclic diamines, and combinations thereof having a chain length (C_{length}) of 2≦C_{length}≦6; and circulating the drilling fluid into the subterranean formation, wherein the SHIA is present in a sufficient amount to reduce shale swelling.

The aqueous based continuous phase may be selected from the group consisting of fresh water, sea water, brine, mixtures of water and water soluble organic compounds, and combinations thereof. The weighting material may be selected from the group consisting of barite, hematite, iron oxide, calcium carbonate, magnesium carbonate, organic and inorganic salts, and combinations thereof. The quaternary ammonium compound may be at least one of choline chloride, chlorcholine chloride, and combinations thereof, and a second compound comprising at least one of, amines, diamines, cyclic amines, cyclic diamines, and combinations thereof.

Other embodiments disclosed herein may provide for a method of treating a subterranean formation that includes providing a quaternary ammonium compound; reacting the quaternary ammonium compound with an amine or diamine to form a DES; introducing the DES formed into a drilling fluid; and circulating the drilling fluid into the subterranean formation in order to treat the formation. Another method may further include forming a DES with a mineral acid or an organic acid prior to introducing the DES into the drilling fluid.

In an embodiment the acid may be selected from the group consisting of hydrochloric acid (HCl), sulfuric acid (H₂SO₄), nitric acid (HNO₃), phosphoric acid (H₃PO₄), carbonic acid, acetic acid (CH₃CO₂H), propionic acid, benzoic acid and combinations thereof.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWING

For a more detailed description of an embodiment of the present disclosure, reference will now be made to the accompanying drawing, wherein:

FIG. 1 is a flow diagram of a method of using a SHIA made of DES for drilling, fracturing, or other operation in a subterranean formation, according to an embodiment of this disclosure.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function.

In this disclosure, the term “subterranean formation” encompasses both areas below exposed earth and areas below earth covered by water such as ocean or fresh water. The term “shale” includes all shale, shale like, and/or clay-containing subterranean formations that exhibit one or more undesirable reactions upon exposure to water-based fluids, wherein undesirable reactions include swelling, disassociation, dispersion, and the like.

In this disclosure, shale hydration inhibition agent(s) is shorthanded as “SHIA” for ease of reference. In this disclosure, poly(propylene imine) is shorthanded as “PPI” for ease of reference; poly(propylene imine) dendrimer(s) is shorthanded as “PPID” for ease of reference; and hydrogenated poly(propylene imine) dendrimer(s) is shorthanded as “HPPID” for ease of reference. In this disclosure, polyamine twin dendrimer is shorthanded as “PTD” for ease of reference.

As used herein, the term ‘deep eutectic solvent’ is used to refer to a type of ionic solvent with special properties, the ionic solvent comprising a mixture which forms a eutectic with a melting point significantly lower than that of its individual components. Such mixtures of proton donors and halide salts are relatively simple to prepare in a pure state. Deep eutectic solvents are non-reactive with water, many are biodegradable, and the toxicological properties of the components are well characterized.

As used herein, the terms ‘cellulosic’ and ‘cellulosic material’ are used to refer to materials of, relating to, or made from cellulose, including chemically-modified cellulose.

In this disclosure, shale hydration inhibition agent(s) is shorthanded as “SHIA” for ease of reference, and deep eutectic solvent(s) is shorthanded as “DES” for ease of reference.

In the following discussion and in the claims, the terms “including” and “comprising” are used in an open-ended fashion, and thus should be interpreted to mean “including, but not limited to . . . ”.

### DETAILED DESCRIPTION

### Overview

In an embodiment, a water-based wellbore construction fluid is used as a drilling fluid in subterranean wells that penetrate through a formation containing shale which swells in the presence of water. In an embodiment, the drilling fluid of this disclosure comprises an aqueous continuous phase and a shale hydration inhibition agent (SHIA). In an embodiment, the drilling fluid of this disclosure comprises an aqueous continuous phase, a weighting material, and a SHIA. The aqueous continuous phase may be any water-based fluid that is compatible with the formulation of a wellbore construction or servicing fluid and is compatible with the SHIA disclosed herein.

In an embodiment, the aqueous based continuous phase is selected from: fresh water, sea water, brine, mixtures of water and water soluble organic compounds and mixtures thereof. The aqueous continuous phase is present in an amount that is sufficient to form a water-based drilling fluid. In some embodiments, the aqueous continuous phase is present in the drilling fluid from about 80 to about 100 by volume. In some embodiments, the aqueous continuous phase is present in the drilling fluid from about 70 to about 95 by volume. In some embodiments, the aqueous continuous phase is present in the drilling fluid from about 65 to about 90 by volume.

The SHIA is present at a sufficient concentration to reduce either or both the surface hydration based swelling and/or the osmotic based swelling of the shale. The exact amount of the shale hydration inhibition agent present in a particular drilling fluid formulation is determined by a trial and error method of testing the combination of drilling fluid and shale formation encountered. As a rule of thumb, the SHIA of this disclosure may be used in a drilling fluid at a concentration of from about 1 to about 18 pounds per barrel (lbs/bbl or ppb), alternatively from about 2 to about 18 ppb, alternatively from about 2 to about 12 ppb.

The use of SHIA not only inhibits shale hydration but also achieves other benefits. For example, the SHIAs of this disclosure are compatible with other drilling fluid components; they are thermally stable; they are toxicologically safer; they have better handling properties; and in some cases they are biodegradable. Therefore, the SHIAs of the present disclosure may be broadly utilized in land based drilling operations as well as offshore drilling operations.

In embodiments, a weighting material is included in the drilling fluid composition to increase the density of the fluid so as to prevent kick-backs and blow-outs. Suitable weighting materials include any type of weighting material that is in solid form, particulate form, suspended in solution, or dissolved in the aqueous phase. For example, a weighting material is chosen from barite, hematite, iron oxide, calcium carbonate, magnesium carbonate, organic and inorganic salts, and combinations thereof. The weight material is present in the drilling fluid at a concentration that is effective to prevent kick-backs and blow-outs, which concentration changes according to the nature of the formation under drilling operations.

In some embodiments, in addition to the other components previously noted, materials generically referred to as gelling materials, thinners, and fluid loss control agents, are optionally added to the water-based drilling fluid. Examples of gelling materials in aqueous drilling fluids are bentonite, sepiolite clay, attapulgite clay, anionic high-molecular weight polymer and biopolymers.

Thinners are included in a drilling fluid to reduce flow resistance and control gelation tendencies. They are also used to reduce filtration and filter cake thickness, to counteract the effects of salts, to minimize the effects of water on the formations drilled, to emulsify oil in water, and to stabilize mud properties at elevated temperatures. Examples of suitable thinners in aqueous drilling fluids are lignosulfonates, modified lignosulfonates, polyphosphates, tannins, and low molecular weight polyacrylates.

In some embodiments, a fluid loss control agent is added to the drilling fluid composition. Examples of suitable fluid loss control agents include synthetic organic polymers, biopolymers, and mixtures thereof. Other examples include modified lignite, polymers, modified starches, and modified celluloses.

In some embodiments, the drilling fluid further comprises an encapsulating agent, which is generally chosen from synthetic materials, organic materials, inorganic materials, bio-polymers, and mixtures thereof. The encapsulating agents may be anionic, cationic or non-ionic in nature. In some embodiments, other additives are included in the drilling fluid composition, such as lubricants, penetration rate enhancers, defoamers, corrosion inhibitors, and lost circulation fluids.

In an embodiment, the drilling fluid of this disclosure further comprises a thickening agent, a shale encapsulator, and other additives such as corrosion inhibitors, lubricity additives. In an embodiment, the drilling fluid of this disclosure may further comprise additional components, such as weighting agents, viscosity agents, fluid loss control agents, bridging agents, lubricants, anti-bit balling agents, neutralizing agents, corrosion inhibition agents, alkali reserve materials and pH buffering agents, surfactants and suspending agents, penetration enhancing agents, proppants, sand for gravel packing, and other similar solids. Other additional components may also be included in the water-based drilling fluid as known to one skilled in the art.

As discussed below, deep eutectic solvents useful as cellulose solvents include choline chloride or chlorcholine chloride reacted with amides, amines, carboxylfc acids, alcohols and/or metal halides. In embodiments of the disclosed method, a DES is pumped downhole after fracturing operations to remove cellulosic material used to thicken fracturing fluids which is left behind in the fractures, on the face of the formation, along the wellbore, etc. The DES can be used alone or in a sequential treatment protocol, for example, DES may be introduced into a subterranean region, followed by introduction thereto of one or more of water, caustic, acid or anhydride as a flush or wash.

In an embodiment, a water-based wellbore servicing fluid is used as a drilling fluid in subterranean wells that penetrate through a formation containing shale which swells in the presence of water. In an embodiment, the drilling fluid of this disclosure comprises an aqueous continuous phase and a shale hydration inhibition agent (SHIA). In an embodiment, the drilling fluid of this disclosure comprises an aqueous continuous phase, a weighting material, and a SHIA.

In an embodiment, the drilling fluid may include an aqueous based continuous phase; a weighting material; and a shale hydration inhibition agent (SHIA) selected from the group of deep eutectic solvents (DES) formed by the reaction of choline chloride or chlorcholine chloride with, amines, diamines, cyclic amines and cyclic diamines. In an embodiment, the diamine may have a chain length (C_{length}) of 2≦C_{length}≦6.

The aqueous continuous phase may be any water-based fluid that is compatible with the formulation of a wellbore construction fluid and is compatible with the SHIA disclosed herein. In some of the embodiments, the SHIA of this disclosure does not react with nor is decomposed by water.

In an embodiment, the aqueous based continuous phase is selected from: fresh water, sea water, brine, mixtures of water and water soluble organic compounds and mixtures thereof. The aqueous continuous phase is present in an amount that is sufficient to form a water-based drilling fluid. In some embodiments, the aqueous continuous phase is present in the drilling fluid from about 80 to about 100 by volume. In some embodiments, the aqueous continuous phase is present in the drilling fluid from about 70 to about 95 by volume. In some embodiments, the aqueous continuous phase is present in the drilling fluid from about 65 to about 90 by volume. For example, water-based muds are sometimes nearly 100% water; water-based muds with just clays and other treatment chemicals contain 92% water and 8% solids whereas a weighted WBM is approximately 65% liquid (water).

The SHIA may be present at a sufficient concentration to reduce either or both the surface hydration based swelling and/or the osmotic based swelling of the shale. The exact amount of the shale hydration inhibition agent present in a particular drilling fluid formulation is determined by a trial and error method of testing the combination of drilling fluid and shale formation encountered. As a rule of thumb, the SHIA of this disclosure may be used in a drilling fluid at a concentration of from about 1 to about 18 pounds per barrel (lbs/bbl or ppb), alternatively from about 2 to about 18 ppb, alternatively from about 2 to about 12 ppb.

The use of SHIA not only inhibits shale hydration but also achieves other benefits. For example, the SHIAs of this disclosure are compatible with other drilling fluid components; they are thermally stable; they are toxicologically safer; they have better handling properties; and in some cases they are biodegradable. Therefore, the SHIAs of the present disclosure may be broadly utilized in land based drilling operations as well as offshore drilling operations.

In embodiments, a weighting material is included in the drilling fluid composition to increase the density of the fluid so as to prevent kick-backs and blow-outs. Suitable weighing materials include any type of weighting material that is in solid form, particulate form, suspended in solution, or dissolved in the aqueous phase. For example, a weighting material is chosen from barite, hematite, iron oxide, calcium carbonate, magnesium carbonate, organic and inorganic salts, and combinations thereof. The weight material is present in the drilling fluid at a concentration that is effective to prevent kick-backs and blow-outs, which concentration changes according to the nature of the formation under drilling operations.

In some embodiments, in addition to the other components previously noted, materials generically referred to as gelling materials, thinners, and fluid loss control agents, are optionally added to the water-based drilling fluid. Examples of gelling materials in aqueous drilling fluids are bentonite, sepiolite clay, attapulgite clay, anionic high-molecular weight polymer and biopolymers.

Thinners are included in a drilling fluid to reduce flow resistance and control gelation tendencies. They are also used to reduce filtration and filter cake thickness, to counteract the effects of salts, to minimize the effects of water on the formations drilled, to emulsify oil in water, and to stabilize mud properties at elevated temperatures. Examples of suitable thinners in aqueous drilling fluids are lignosulfonates, modified lignosulfonates, polyphosphates, tannins, and low molecular weight polyacrylates.

In some embodiments, a fluid loss control agent is added to the drilling fluid composition. Examples of suitable fluid loss control agents include synthetic organic polymers, biopolymers, and mixtures thereof. Other examples include modified lignite, polymers, modified starches, and modified celluloses.

In some embodiments, the drilling fluid further comprises an encapsulating agent, which is generally chosen from synthetic materials, organic materials, inorganic materials, bio-polymers, and mixtures thereof. The encapsulating agents may be anionic, cationic or non-ionic in nature. In some embodiments, other additives are included in the drilling fluid composition, such as lubricants, rate of penetration (ROP) enhancers, defoamers, corrosion inhibitors, and lost circulation fluids.

In an embodiment, the drilling fluid of this disclosure further comprises a thickening agent, a shale encapsulator, and other additives such as corrosion inhibitors or lubricity additives. In an embodiment, the drilling fluid of this disclosure may further comprise additional components, such as weighting agents, viscosity agents, fluid loss control agents, bridging agents, lubricants, anti-bit balling agents, neutralizing agents, corrosion inhibition agents, alkali reserve materials and pH buffering agents, surfactants and suspending agents, penetration enhancing agents, proppants, sand for gravel packing, and other similar solids. Other additional components may also be included in the water-based drilling fluid as known to one skilled in the art.

Overview of SHIA

In an embodiment, a drilling fluid composition comprises a SHIA to reduce clay swelling in a wellbore. In some embodiments, the SHIA comprises derivatives of propylamines. In some embodiments, the SHIA comprises hydrogenated poly(propylene imine) dendrimers, i.e., HPPID. In some embodiments, the SHIA comprises polyamine twin dendrimers. In an embodiment, the SHIA is a propylamine derivative. In an embodiment, the SHIA is a HPPID. In an embodiment, the SHIA is a polyamine twin dendrimer (PTD).

In an embodiment, a drilling fluid composition comprises a SHIA usable to reduce clay swelling in a wellbore. In some embodiments, the SHIA comprises deep eutectic solvents (DES). In some embodiments, the SHIA may include DES formed from reaction of a first compound comprising an ammonium compound, and a second compound comprising at least one of amines, diamines, cyclic amines, cyclic diamines, and combinations thereof.

Propylamine Derivatives as SHIA

In an embodiment, the SHIA in a drilling fluid composition of this disclosure is a derivative of propylamine having the formula:

R—Y—(CH₂)ₙ—NH₂

wherein n=3; Y═O or N (both having an unshared pair of electrons); R=one or more —CH₃ groups or a morpholino group.

In an embodiment, the SHIA in a drilling fluid composition of this disclosure is 3-methoxypropylamine (MOPA), a derivative of propylamine having the formula:

CH₃—O—(CH₂)₃—NH₂

In an embodiment, the SHIA in a drilling fluid composition of this disclosure is dimethylaminopropylamine (DMAPA), a derivative of propylamine having the formula:

(CH₃)₂—N—(CH₂)₃—NH₂

In an embodiment, the SHIA in a drilling fluid composition of this disclosure is N-aminopropylmorpholine (APM), a derivative of propylamine having the formula:

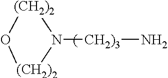

wherein R=a cyclic morpholino group and Y═N.

In embodiments, propylamine derivatives as disclosed herein may be used in a drilling fluid at a concentration of from about 1 to about 20 pounds per barrel (lbs/bbl or ppb), alternatively from about 2 to about 18 ppb, alternatively from about 2 to about 12 ppb.

In an embodiment, a method of reducing shale swelling in a wellbore comprises circulating in the well a water-based drilling fluid composition comprising an aqueous continuous phase, a weighting material, and a SHIA, wherein the SHIA comprises at least one propylamine derivative as disclosed herein.

In embodiments, propylamine derivatives are generally highly soluble in aqueous drilling fluids. Acid treatment of propylamine derivatives increases their solubility in aqueous drilling fluids.

In some embodiments, the propylamine derivatives as SHIA in a water-based drilling fluid composition, before being introduced into the drilling fluid composition, may be pretreated with an acid so that the pH is adjusted to be in the range of 6.0-10.0, alternatively in the range of 6.5-9.5, alternatively in the range of 7.0-9.0. Suitable acids for this pretreatment include mineral acids and organic acids. Examples of mineral acids are hydrochloric acid (HCl), sulfuric acid (H₂SO₄), nitric acid (HNO₃), and phosphoric acid (H₃PO₄) Examples of organic acids are carbonic acid, formic acid, acetic acid, propionic acid, and benzoic acid. In some cases, acid treatment increases the solubility of these SHIAs in aqueous drilling fluid compositions. In some cases, acid treatment causes these SHIAs to be less volatile and reduces the smell of these SHIAs. In some cases, acid treatment improves the handling properties of SHIAs so that workers will deal with a relatively pH neutral composition.

In some embodiments, a water-based drilling fluid, before the addition of SHIA, is treated with an acid so that the pH is adjusted to be in the range of 6.5-12.0, alternatively in the range of 7.0-11.0, alternatively in the range of 9.0-10.0. The drilling fluid is pH adjusted to insure better solids wetting, lower corrosion rates, better emulsification, and other desirable properties. Suitable acids for this pretreatment include mineral acids and organic acids. Examples of mineral acids are hydrochloric acid (HCl), sulfuric acid (H₂SO₄), nitric acid (HNO₃), and phosphoric acid (H₃PO₄) Examples of organic acids are carbonic acid, formic acid, acetic acid, propionic acid, and benzoic acid. The pH of the drilling fluid after the addition of SI-TIAs substantially remains the same because the amount of SHIAs added is not large enough to cause significant pH changes.

In embodiments, the propylamine derivatives as disclosed herein as the SHIA in a water-based drilling fluid composition are not hydrolyzed in the presence of water. Furthermore, these propylamine derivatives are also stable (not hydrolyzed) at a temperature in the range of from about 100° F. to about 500° F., alternatively from about 150° F. to about 400° F., alternatively from about 150° F. to about 300° F.

Hydrogenated PPI Dendrimers as SHIA

In an embodiment, the SHIA in a drilling fluid composition of this disclosure is a hydrogenated poly(propyleneimine) dendrimer, i.e., HPPID. Dendrimers or dendritic molecules are repeatedly branched molecules. Some dendritic molecules are known and are described, for example, in Angew. Chem. Int. Ed. Engl., 29:138-175 (1990), incorporated herein by reference in its entirety. This article describes a number of different dendrimers, for example polyamidoamine (PAMAM) dendrimers, which are also described in U.S. Pat. No. 4,507,466; and polyethyleneimine (PEI) dendrimers, which are also described in U.S. Pat. No. 4,631,337. The synthesis of the PPI dendrimers of this disclosure is according to the synthetic scheme in Angew. Chem. Int. Ed. Engl., 32(9):1308-1311 (1993), incorporated herein by reference in its entirety.

In some embodiments, the Michael Reaction takes place between ammonia and three mols of acrylonitrile at 80° C. for 1 hour to produce tricyanoethylene amine as the core of the dendrimer—step (1) in scheme 1. Tricyanoethylene amine is then reduced with H₂ over a Raney Nickel catalyst via hydrogenation reactions step (2) in scheme 1, which produces aminotrispropylamine as the first generation HPPID. Aminotrispropylamine is further reacted with an additional six mols of acrylonitrile via the Michael Reaction for the growth of dendritic branches—step (3) in scheme 1. The resulting product is again reduced with H₂ over a Raney Nickel catalyst via hydrogenation reactions-step (4) in scheme 1, which renders the second generation HPPID. This synthesis process may be repeated to grow the dendritic branches, from the core to three branches, to six branches, to twelve branches, which process is called starburst branching.

In embodiments, the MW of HPPID as SHIA used in a drilling fluid composition is in the range of from about 150 to about 5800, alternatively from about 500 to about 2900, alternatively from about 1100 to about 2600. In some embodiments, the molecular weight (MW) of HPPID as SHIA used in a drilling fluid composition is in the range of from about 182 to about 5606, alternatively from about 518 to about 2534, alternatively from about 1190 to about 2534.

In embodiments, HPPID as disclosed herein may be used in a drilling fluid at a concentration of from about 1 to about 20 pounds per barrel (lbs/bbl or ppb), alternatively from about 2 to about 18 ppb, alternatively from about 2 to about 12 ppb.

In an embodiment, a method of reducing shale swelling in a wellbore comprises circulating in the well a water-based drilling fluid composition comprising an aqueous continuous phase, a weighting material, and a SHIA, wherein the SHIA comprises at least one HPPID as disclosed herein.

In embodiments, HPPIDs are generally highly soluble in aqueous drilling fluids. Acid pretreatment of HPPIDs increases their solubility in some aqueous drilling fluids.

In some embodiments, the HPPID as SHIA in a water-based drilling fluid composition, before being introduced into the drilling fluid composition, is pretreated with an acid so that the pH is adjusted to be in the range of 6.0-10.0, alternatively in the range of 6.5-9.5, alternatively in the range of 7.0-9.0. Suitable acids for this pretreatment include mineral acids and organic acids. Examples of mineral acids are hydrochloric acid (HCl), sulfuric acid (H₂SO₄), nitric acid (HNO₃), and phosphoric acid (H₃PO₄). Examples of organic acids are carbonic acid, formic acid, acetic acid, propionic acid, and benzoic acid. In some cases, acid treatment increases the solubility of these SHIAs in aqueous drilling fluid compositions. In some cases, acid treatment causes these SHIAs to be less volatile and reduces the smell of these SHIAs. In some cases, acid treatment improves the handling properties of SHIAs so that workers will deal with a relatively pH neutral composition.

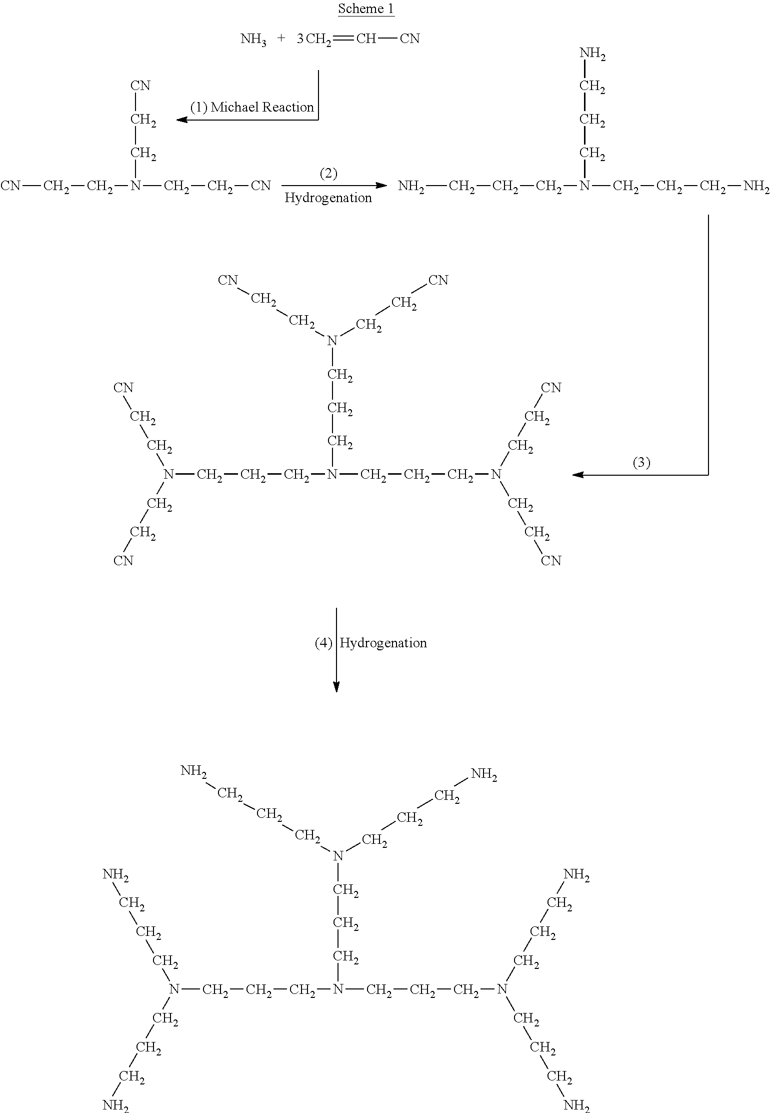

In some embodiments, a water-based drilling fluid, before the addition of SHIA, is treated with an acid so that the pH is adjusted to be in the range of 6.5-12.0, alternatively in the range of 7.0-11.0, alternatively in the range of 9.0-10.0. The drilling fluid is pH adjusted up or down to insure better solids wetting, lower corrosion rates, better emulsification, and other desirable properties. Suitable acids for this pretreatment include mineral acids and organic acids. Examples of mineral acids are hydrochloric acid (HCl), sulfuric acid (H₂SO₄), nitric acid (HNO₃), and phosphoric acid (H₃PO₄). Examples of organic acids are carbonic acid, formic acid, acetic acid, propionic acid, and benzoic acid. The pH of the drilling fluid after the addition of SHIAs substantially remains the same because the amount of SHIAs added is not large enough to cause significant pH changes.

In embodiments, the HPPID as disclosed herein as the SHIA in a water-based drilling fluid composition is not hydrolyzed in the presence of water. Furthermore, these HPPIDs are also stable (not hydrolyzed) at a temperature in the range of from about 100° F. to about 500° F., alternatively from about 150° F. to about 400° F., alternatively from about 150° F. to about 300° F.

Polyamine Twin Dendrimers as SHIA

In an embodiment, the SHIA in a drilling fluid composition of this disclosure is a polyamine twin dendrimer (PTD). In some embodiments, the core of the PTD has the formula:

H₂N—(CH₂)ₓ—NH₂

wherein 2≦x≦6. Examples of suitable PTD cores include ethylene diamine, propylene diamine, and hexamethylene diamine. Other suitable polyamines for the construction of the PTD of this disclosure are contemplated as known to one skilled in the art.

In an embodiment, PTD is synthesized from ethylene diamine (H₂N—CH₂CH₂—NH₂) as the core. The Michael Reaction takes place between ethylene diamine and two mols of acrylonitrile (CH₂═CH—CN) at 80° C. for 1 hour to produce NC—CH₂CH₂—[HN—CH₂CH₂—NH]—CH₂—CH₂—CN, which is then reduced with H₂ over a Raney Nickel catalyst to produce the following PTD:

NH₂—CH₂—CH₂CH₂—[HN—CH₂CH₂—NH]—CH₂—CH₂—CH₂—NH₂

During the hydrogenation reaction, the efficiency of the catalyst decreases and catalyst may be stripped off of the support. In order to avoid product contamination with catalyst, the reaction time is controlled before catalyst stripping takes place.

This process may be repeated to grow longer polyamine twin dendrimers. In another embodiment, 1,3-propane diamine (H₂N—CH₂—CH₂—CH₂—NH₂) is utilized as the core for PTDs. In the description to follow, the core for a PTD is represented by “Q” for ease of reference.

In an embodiment, four mols of acrylonitrile (CH₂═CH—CN) is reacted with core A via the Michael Reaction, the product is then reduced with H₂ over a Raney Nickel catalyst via hydrogenation reactions, which renders the first generation PTDs. If core A is 1,3-propane diamine, scheme 2 follows:

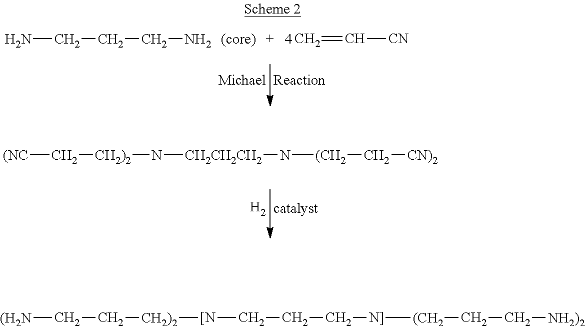

Repeat the above process and let Q=core and B=(CH₂—CH₂—CH₂—NH₂), the following PTD may be produced: (B)₄—(B)₂-[Q]-(B)₂—(B)₄ (2^{nd} generation), (B)₈—(B)₄—(B)₂-[Q]-(B)₂—(B)₄—(B)₈ (3^{rd} generation), (B)₂ⁿ . . . —(B)₈—(B)₄—(B)₂-[Q]-(B)₂—(B)₄—(B)₈— . . . (B)₂ⁿ (n^{th} generation)

In embodiments, the molecular weight (MW) of PTD as SHIA used in a drilling fluid composition is in the range of from about 250 to about 7500, alternatively from about 400 to about 3600, alternatively from about 420 to about 1800. In some embodiments, the molecular weight (MW) of PTD as SHIA used in a drilling fluid composition is in the range of from about 294 to about 7014, alternatively from about 448 to about 3430, alternatively from about 448 to about 1638.

In embodiments, PTD as disclosed herein may be used in a drilling fluid at a concentration of from about 1 to about 20 pounds per barrel (lbs/bbl or ppb), alternatively from about 2 to about 18 ppb, alternatively from about 2 to about 12 ppb.

In an embodiment, a method of reducing shale swelling in a wellbore comprises circulating in the well a water-based drilling fluid composition comprising an aqueous continuous phase, a weighting material, and a SHIA, wherein the SHIA comprises at least one polyamine twin dendrimer as disclosed herein.

In embodiments, PTDs are generally highly soluble in aqueous drilling fluids. Acid treatment of PTDs increases their solubility in aqueous drilling fluids.

In some embodiments, the PTD as SHIA in a water-based drilling fluid composition, before being introduced into the drilling fluid composition, is pretreated with an acid so that the pH is adjusted to be in the range of 6.0-10.0, alternatively in the range of 6.5-9.5, alternatively in the range of 7.0-9.0. Suitable acids for this pretreatment include mineral acids and organic acids. Examples of mineral acids are hydrochloric acid (HCl), sulfuric acid (H₂SO₄), nitric acid (HNO₃), and phosphoric acid (H₃PO₄) Examples of organic acids are carbonic acid, formic acid, acetic acid, propionic acid, and benzoic acid. In some cases, acid treatment increases the solubility of these SHIAs in aqueous drilling fluid compositions. In some cases, acid treatment causes these SHIAs to be less volatile and reduces the smell of these SHIAs. In some cases, acid treatment improves the handling properties of SHIAs so that workers will deal with a relatively pH neutral composition.

In some embodiments, a water-based drilling fluid, before the addition of SHIA, is treated with an acid so that the pH is adjusted to be in the range of 6.5-12.0, alternatively in the range of 7.0-11.0, alternatively in the range of 9.0-10.0. The drilling fluid is pH adjusted to insure better solids wetting, lower corrosion rates, better emulsification, and other desirable properties. Suitable acids for this pretreatment include mineral acids and organic acids. Examples of mineral acids are hydrochloric acid (HCl), sulfuric acid (H₂SO₄), nitric acid (HNO₃), and phosphoric acid (H₃PO₄) Examples of organic acids are carbonic acid, formic acid, acetic acid, propionic acid, and benzoic acid. The pH of the drilling fluid after the addition of SHIAs substantially remains the same because the amount of SHIAs added is not large enough to cause significant pH changes.

In embodiments, the polyamine twin dendrimers as disclosed herein as the SHIA in a water-based drilling fluid composition are not hydrolyzed in the presence of water. Furthermore, these PTDs are also stable (not hydrolyzed) at a temperature in the range of from about 100° F. to about 500° F., alternatively from about 150° F. to about 400° F., alternatively from about 150° F. to about 300° F.

### EXAMPLES

To further illustrate various embodiments of the present invention, the following examples are provided. These examples are intended to be illustrative, and no limitations to the present invention should be drawn or inferred from the examples presented herein.

The following tests (Examples 1-4) are conducted to demonstrate the maximum amount of API bentonite that can be inhibited by a single 10 pound per barrel (ppb) treatment of propylamine derivatives as the SHIA. The test procedure employs pint jars that are filled to 350 ml with tap water. Ten and a half (10.5) grams of swelling/hydration inhibitor, equaling 10 ppb in the field, is added and the pH is adjusted to a value of at least 9.0 with HCl. To the resulting solution is added a 10 ppb portion of API bentonite and after stirring for 30 minutes, the rheological properties of the slurry are determined and the sample is heat-aged overnight at about 150° F. The following day, the samples are cooled and their rheological properties are again determined. This procedure is carried out until all samples are too thick to measure. Gel Strengths (lbs/100 ft²) are run at 10 seconds and 10 minutes.

### Example 1

Typical results are as follows: a polyetheramine available from Huntsman Corporation as D-230 and investigated in Patel et al., U.S. Pat. No. 6,857,485 gave the following rheological results after being tested as described above wherein the clay content of the lab fluid represented 160 ppb. At 170 ppb the fluid became too thick to obtain readings on.

| | |
|---|---|
| Plastic Viscosity (cps) | 50 |
| Yield Point (lbs/100 ft²) | 80 |
| Gel Strength (lbs/100 ft²) | 65/80 |

### Example 2

Submitting 3-methoxypropylamine (MOPA) to the same test procedure, at the same treatment concentrations gave the following results. The clay content of the sample was 160 ppb.

| | |
|---|---|
| Plastic Viscosity (cps) | 11 |
| Yield Point (lbs/100 ft²) | 6 |
| Gel Strength (lbs/100 ft²) | 3/12 |

As can be seen, utilizing 3-methoxypropylamine (MOPA) is superior to the use of polyetheramine that is currently practiced because the methyl group attached to the 0 is an electron donor which increases the amine's pKa to 10.11. This is an unusual response. The propyl group has enough flexibility to allow the transfer of electrons with efficiency.

### Example 3

To insure that a propyl group separating two atoms each having an unshared pair of electrons (N, O, S), exhibited the best response, 2-methoxyethylamine purchased from Sigma Aldrich Chemical Company (MOEA, CH₃—O—CH₂—CH₂—NH₂) was tested employing the method cited above and the results obtained were compared to 3-methoxypropylamine (MOPA). At 160 ppb, the following results were obtained. It should be noted that the pKa for MOEA is 9.2 which supports the flexibility and electron transfer theory attached to the propylamine theory.

| | |
|---|---|
| Plastic Viscosity (cps) | TTTM |
| Yield Point (lbs/100 ft²) | — |
| Gel Strength (lbs/100 ft²) | — |

TTTM = Too Thick To Measure

### Example 4

A 3-methoxypropylamine salt, of acetic acid, was employed in the same test procedure detailed above and the following results were obtained at 160 ppb clay.

| | |
|---|---|
| Plastic Viscosity (cps) | 7.5 |
| Yield Point (lbs/100 ft²) | 5 |
| Gel Strength (lbs/100 ft²) | 3/6 |

Comparing salts, at 120 ppb, the results for two MOPA salts, hydrochloric and acetic acid were:

| | HCl | CH₃COO⁻ |
|---|---|---|
| Plastic Viscosity (cps) | 13 | 7.5 |
| Yield Point (lbs/100 ft²) | 19 | 5 |
| Gel Strength (lbs/100 ft²) | 6/8 | 3/6 |

As can be seen, there is a performance advantage apparently gained from using 3-methoxypropylamine and reacting it with a buffering acid such as acetic or phosphoric acids. In conclusion, the following data could be extrapolated from the test data obtained.

lbs./bbl. at which each additive was extrapolated to fail

| | | |
|---|---|---|
| D-230•HCl | 170 lbs./bbl. | (actual data) |
| MOPA•HCl | >190 lbs./bbl. | (actual data) |
| MOPA•CH₃COO⁻ | >>190 lbs/bbl. | (actual data) |

### Example 5

The following test is conducted to demonstrate the maximum amount of API bentonite that can be inhibited by a single 10 pound per barrel (ppb) treatment of a polyamine twin dendrimer as the SHIA. The test procedure employs pint jars which are filled to 350 ml with tap water. Ten and a half (10.5) grams of swelling/hydration inhibitor, equaling 10 ppb in the field, is added and the pH adjusted to a value of at least 9.0. To the resulting solution is added a 10 ppb portion of API bentonite and after stirring for 30 minutes, the rheological properties of the slurry are determined and the sample is heat aged overnight at about 150° F. The following day, the samples are cooled and their rheological properties are again determined. This procedure is carried out until all samples are too thick to measure.

To further demonstrate the theory of flexibility and electron transfer 1,1,3,3-tetraminopropyl propylenediamine, shown below, was tested in the procedure outlined above.

(H₂N—CH₂—CH₂—CH₂)₂[N—CH₂—CH₂—CH₂—N]CH₂—CH₂—CH₂—NH₂)₂

The results obtained were found to be as expected. The clay concentration was purposely made to yield 160 ppb.

| | |
|---|---|
| Plastic Viscosity (cps) | 17 |
| Yield Point (lbs/100 ft²) | 23 |
| Gel Strength (lbs/100 ft²) | 1/8 |

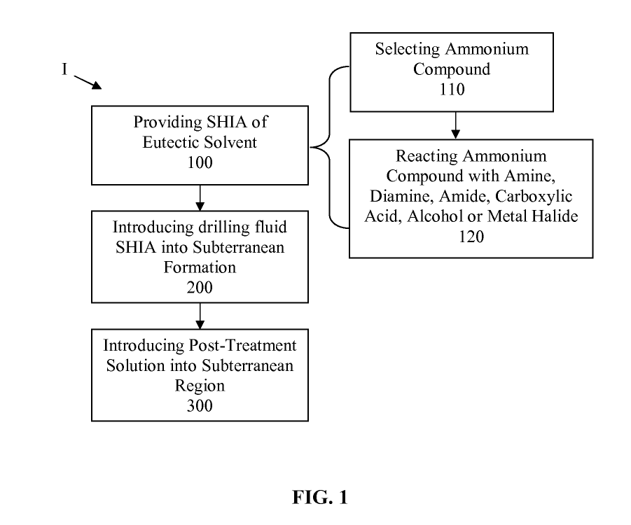

Herein disclosed is a method of treating a subterranean region. FIG. 1 is a flow diagram of a method I for treating a subterranean region. Method I is utilized to solubilize cellulose and/or chemically-modified cellulosic polymers used in drilling and fracturing operations. The method may be used to remove cellulose or chemically-modified cellulosic polymers within a subterranean region, to promote removal thereof. Such cellulose may be found in the wellbore as a result of subterranean drilling and fracturing operations. For example, cellulosic materials are typically used as viscosity modifiers in water-based drilling and fracturing fluids. Such cellulosic materials can be selected from the group containing guar, cellulose and chemically-modified celluloses such as carboxymethylcellulose (CMC), hydroxylethylcellulose (HEC) and the like.

Method I comprises providing a eutectic solvent at 100 and introducing the eutectic solvent into the wellbore at 200, to solubilize and/or remove cellulosic materials therein. The method may further comprise introducing post-treatment solution into the wellbore at 300. As illustrated in FIG. 1, providing a eutectic solvent 100 comprises selecting an ammonium compound at 110 and reacting the ammonium compound to form eutectic solvent at 120.

II. Eutectic Solvent. According to this disclosure, a Deep Eutectic Solvent (DES) is formed by reacting an ammonium compound, for example N-(2-hydroxyethyl) trimethyl-ammonium chloride (choline chloride), with a hydrogen-bond donor (HBD) such as carboxylic acids, amines, amides and alcohols. These liquids have physical and solvent properties that are similar to ionic liquids formed from discrete ions and are easy to produce by simply reacting common commodity chemicals such as choline chloride and carboxylic acids or amines as further discussed hereinbelow.

Ammonium Compound Method I comprises providing a eutectic solvent 100. Providing a eutectic solvent 100 comprises selecting an ammonium compound 110 and reacting the ammonium compound 120 to produce a eutectic solvent. In applications, the ammonium compound is an ammonium halide. In embodiments, the ammonium compound is an ammonium chloride. In embodiments, the ammonium compound is ammonium chloride. In applications, the ammonium compound is a quaternary ammonium compound. In applications, the quaternary ammonium compound is selected from the group consisting of quaternary ammonium halides. In applications, the quaternary ammonium halide is selected from the group consisting of quaternary ammonium chlorides.

In embodiments, the ammonium compound is selected from the group consisting of the ammonium chlorides having the structure:

(R₁R₂R₃)—N⁺—R₄—OH Cl⁻ (1)

wherein R₁, R₂, R₃, and R₄ are each selected from the group consisting of H and CₓH_{y}, wherein 1≦x≦18 and 3≦y≦37. R₁, R₂, R₃ and R₄ can be branched or linear and can be alkyl, aryl or alkylaryl. In embodiments, R₁, R₂, R₃, and R₄ are not hydrogen, and the ammonium compound is a quaternized ammonium chloride having the structure as in Eq. (1). In embodiments, R₁, R₂, R₃, R₄ or any combination thereof is selected from the group consisting of methyl-, ethyl-, octadecyl-, phenyl, benzyl- and combinations thereof. In applications, R₁, R₂ and R₃ are methyl, and R₄ is ethyl. In this embodiment, the ammonium compound is the quaternary ammonium compound N-(2-hydroxyethyl) trimethyl-ammonium chloride (CH₃)₃—N⁺—CH₂CH₂OHCl⁻, also known as choline chloride or vitamin B4.

In embodiments, the ammonium compound is selected from the group consisting of ammonium chlorides having the structure:

(R₁R₂R₃)—N⁺—R₄Cl (2)

wherein R₁, R₂, R₃ and R₄ may be the same or different, and can be hydrogen or branched or linear alkyl, alkylaryl, or aryl groups. In applications, R₁, R₂, R₃ and R₄ are selected from the group consisting of H and CₓH_{y}, wherein 1≦x≦18 and 3≦y≦37. In applications, R₁, R₂ and R₃ are selected from the group consisting of methyl-, ethyl-, octadecyl-, phenyl, benzyl-, methoxy-, ethoxy-, and the like. In applications, R₁, R₂ and R₃ are methyl and R₄ is ethyl. In such an embodiment, the ammonium chloride may be the quaternary ammonium chloride, 2-chloro: N,N,N-trimethylethanaminium chloride. In embodiments, R₁, R₂, R₃, and R₄ are hydrogen, and the ammonium compound is ammonium chloride.

In embodiments, the ammonium compound is selected from the group consisting of chloro-substituted ammonium chlorides having the structure:

Cl⁻(R₁R₂R₃)—N⁺—R₄Cl(3)

wherein R₁, R₂, R₃ and R₄ may be the same or different, and can be hydrogen or branched or linear alkyl, alkylaryl, or aryl groups. In applications, R₁, R₂, R₃ and R₄ are selected from the group consisting of methyl-, ethyl-, octadecyl-, phenyl, benzyl-, and the like. In applications, R₁, R₂ and R₃ are methyl groups and R₄ is an ethyl group. In this embodiment, the ammonium compound is the quaternary ammonium chloride, chlorcholine chloride, [2-chloroethyl-trimethyl-azanium chloride, Cl⁻(CH₃)₃N⁺CH₂CH₂Cl].

In embodiments, the ammonium compound is selected from the group consisting of ammonium chloride, choline chloride, [N-(2-Hydroxyethyl) trimethyl ammonium chloride, (CH₃)₃—N⁺—CH₂CH₂OHCl⁻], chlorcholine chloride, and 2-chloro-N,N,N-trimethylethanaminium. In embodiments, the ammonium compound is a quaternary ammonium compound selected from the group consisting of chlorcholine chloride, choline chloride, 2-chloro-N,N,N-trimethylethanaminium, and combinations thereof.

Second Compound. Reacting the ammonium compound to produce a eutectic solvent at 120 comprises reacting the ammonium compound with a second compound to produce a deep eutectic solvent. The second compound is a hydrogen bond donor (HBD). In applications, the second compound is selected from amines, amides, carboxylic acids, alcohols and metal halides. In applications, the second compound has a chain length (C_{length}) in the range of from 1 to 18; from 1 to 10; or from 1 to 8.

In applications, the second compound is an amine. In applications, the second compound is selected from mono- or di-functional amines. In applications, the second compound is selected from the group consisting of compounds with the structure:

R₁—(CH₂)ₓ—R₂, (4)

wherein R₁ and R₂ are —NH₂, —NHR₃, or —NR₃R₄ and 2≦x≦6. In applications, the di-functional amine compound is ethylene diamine, H₂N—(CH₂)₂—NH₂.

In applications, the second compound is an amide. In applications, the second compound is selected from the group consisting of compounds with the structure:

R—CO—NH₂, (5)

wherein R is H, NH₂, CH₃, or CF₃. In applications, R is NH₂, and the compound is urea, H₂N—CO—NH₂ In applications, the second compound is selected from 1-methyl urea, (CH₃NHCONH₂), 1,3-dimethylurea (CH₃NHCONHCH₃), thiourea ((NH₂)₂CS), and acetamide (CH₃CONH).

In specific embodiments, the deep eutectic solvent (DES) is a reaction product of a di-functional amine and N-(2-hydroxyethyl) trimethyl-ammonium chloride, generically choline chloride.

As discussed further in Examples 6 and 7 hereinbelow, reacting the ammonium compound may comprise combining the ammonium compound with an amide (e.g., urea) at a 1:2 mol ratio. The mixture is heated, with stirring, and allowed to react until a clear, viscous, uniform solution is formed. The mixture may be heated to a temperature no greater than 100° C. The liquid is then allowed to cool to room temperature. Cooling to room temperature may comprise cooling at a rate of less than 1° C./min.

In applications, the second compound is selected from carboxylic acids. In applications, the second compound is selected from mono- and di-functional organic alkyl and aryl acids. In applications, the second compound is a mono-functional carboxylic acid. In embodiments, the ammonium compound is reacted with the mono-carboxylic acid at a 1:2 molar ratio of ammonium compound to mono-functional carboxylic acid to form the eutectic solvent. In applications, the mono-carboxylic acid is selected from phenylpropionic acid (C₆H₆CH₂CH₂CO₂H), phenylacetic acid (C₆H₆CH₂CO₂H), and combinations thereof.

In applications, the second compound is a di-functional carboxylic acid. As discussed in Example 3 hereinbelow, in such embodiments, the ammonium compound may be reacted with the di-functional carboxylic acid at a 1:1 molar ratio. In applications, the second compound is selected from oxalic acid (HO₂CCO₂H), malonic acid (HO₂CCH₂CO₂H), succinic acid (HO₂CCH₂CH₂CO₂H), and combinations thereof.

In embodiments, the second compound is selected from tris or tri-functional carboxylic acids. In such embodiments, the solvent may be formed at a 30-35 mol % acid. Suitable tri-functional carboxylic acids include citric acid and tricarballylic acid.

In applications, the second compound is a metal halide. The metal halide may be selected from the group consisting of aluminum chloride, zinc chloride, tin chloride, iron chloride, and combinations thereof. The latter three molten product salts have the advantage that they are not water sensitive, although they are found to be, in general, more viscous than the aluminum derivative. The depression of the freezing points may be as much as 190° C.

C. Reacting Ammonium Compound with Second Compound. As discussed further in Examples 6 and 7 hereinbelow, reacting the ammonium compound may comprise combining the ammonium compound (e.g., quaternary ammonium halide) with an amide (e.g., urea) at a 67 mol percent amide; with a mono-functional carboxylic acid at a 67 mol percent mono-functional carboxylic acid; with a di-functional carboxylic acid at 50 mol percent di-functional carboxylic acid; with a tri-carboxylic acid at 30-35 mol percent; or with metal halide at a 30-67 mol percent metal halide, depending upon the charge on the metal halide. For example, ZnCl₂ reacts in a different ratio than FeCl₃. In the specific case of ZnCl₂ the reaction yields [(CHCl—)(ZnCl₂)₂] which reflects a reaction ratio of 1:2 or 67 mol percent metal or zinc chloride.

The mixture comprising the ammonium compound and second compound is heated, with stirring, and allowed to react until a clear, viscous, uniform solution is formed. The mixture may be heated to a temperature no greater than 100° C. The liquid is then allowed to cool to room temperature. Cooling to room temperature may comprise cooling at a rate of less than 1° C./m in.

The DES may have a solubility for cellulose of at least 30 weight %, at least 40 weight %, at least 45 weight %, at least 50 weight %, or at least 55 weight %.

Introducing the Eutectic Solvent into Subterranean Region.

The method further comprises introducing the eutectic solvent into a subterranean region 200. The eutectic solvent may be introduced into a subterranean region such as a wellbore, casing, fracture or face of a formation. The subterranean region may contain therein cellulose or cellulosic material to be solubilized via the eutectic solvent and thus may be removed from the subterranean region. Cellulose or cellulosic materials may be present in the subterranean region as a result of fracturing and/or mud thickening operations, for example, utilized in a drilling operation. The cellulose or chemically-modified cellulose may have been introduced into the subterranean region as a component of a drilling fluid or a fracturing fluid. In specific applications, the DES is introduced into a formation which has been fractured utilizing a fracturing fluid comprising cellulose in order to clean the well bore and the resulting fractures and remove any cellulosic materials that may have deposited during the fracturing operation and now hinder production from the fractures.

In other applications, the DES is introduced into the subterranean region as a component of a drilling fluid (i.e., a fracturing fluid, drilling mud, or other drilling fluid) which further comprises cellulose or cellulosic materials. In this manner, the DES is utilized as an additive to maintain solubility of the cellulose or cellulosic material (e.g., chemically modified cellulose which may, in the absence of the DES, hydrolyze to cellulose, becoming insoluble in the drilling fluid), preventing/minimizing deposition therein.

The DES is introduced into the subterranean region at conditions known to those of skill in the art to be suitable for the introduction of fluids downhole. In applications, the DES is introduced into the subterranean region at a temperature in the range of from about 50° C. to about 150° C. Alternatively, a temperature in the range of from about 65° C. to about 135° C. In applications, the DES is pumped into the subterranean region at a pressure in the range of from about 500 to about 25,000 psig. Alternatively, a pressure in the range of from about 1,000 to about 10,000 psig. Alternatively, a pressure in the range of from about 1,000 to about 5,000 psig.

Introducing Post-Treatment Solution into Subterranean Region.

The method I may further comprise introducing post-treatment solution into the subterranean region 300. In instances, the DES is used alone, with no post-treatment. In applications, the Deep Eutectic Solvents (DES) are used and a wash is subsequently introduced into the subterranean region. The wash may be selected from a water wash, a caustic wash, an anhydride wash, an acid wash, ora combination thereof. A caustic wash may be selected from sodium hydroxide and potassium hydroxide. An anhydride wash may comprise acetic anhydride.

While the preferred embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

To further illustrate various illustrative embodiments of the present invention, the following examples are provided.

### Examples

### Example 6

### Synthesis of Choline Chloride/Amide Deep Eutectic Solvent (DES)

Urea which has a melting point of 133° C. (271° F.) is combined with N-(2-hydroxyethyl) trimethylammonium chloride (choline chloride) which has a melting point of 302° C. (575° F.) in a 2:1 molar ratio. One (1) mol (139.6 grams) of choline chloride, [N-(2-hydroxyethyl) trimethylammonium chloride, [(CH₃)₃N⁺CH₂CH₂OH], FW=139.6 g/mol] is employed as a dry powder or flake and is added to 2 mols of urea, an amide, [120 grams [(NH₂)₂CO, FW=60 g/mol]. With stirring, the dry mixture is heated to 80° C. (176° F.) until the solids have all been dissolved to affect a reaction. The reaction is continued until a clear, viscous, uniform solution is formed. The liquid is then allowed to cool to room temperature at a rate no faster than 1° C./min. The yield is quantitative and the product has a melting point of 12° C. (˜53.6° F.). The variables for this deep eutectic solvent are: P=7.63×10⁻³; η_{calc}=11cP; Vₘ=210.1 cm³mol⁻¹; V_{free}=9.1%; and E_{η}=58 kJmol⁻¹.

Numerous other choline chloride (ChCl⁻)/amide compounds can be synthetically prepared employing the method detailed above including but not limited to 1-methyl urea (CH₃NHCONH₂, m.p.=29° C.), 1,3-dimethylurea (CH₃NHCONHCH₃, m.p.=70° C.), thiourea ((NH₂)₂CS, m.p.=69° C.), acetamide (CH₃CONH₂, m.p.=51° C.) and others.

### Example 7

### Synthesis of Chlorcholine Chloride/Amide Deep Eutectic Mixtures (DES)

Chlorcholine chloride [Cl⁺(CH₃)₃N⁺CH₂CH₂Cl), 12.96 g, 0.082 mol) is added to urea (9.78 g., 0.163 mol) and the mixture heated to 80° C. (176° F.) with stirring for approximately 30 minutes. A clear, viscous, uniform solution is formed and allowed to cool to room temperature at a rate of approximately 1° C./min. The liquid can be maintained for at least a month when protected against moisture.

As with choline chloride in Example 1, numerous chlorcholine chloride/amide derivatives can be prepared. The reaction time is reduced due to the higher reactivity coefficient of the chloro-derivative.

### Example 8

### Synthesis of Choline Chloride/Carboxylic Acid Deep Eutectic Mixtures (DES)

Based on the method presented in Example 1, it becomes apparent that a eutectic is formed at a composition of 67% mol urea. From this data, it can be inferred that to form the eutectic two carboxylic acid molecules are required to complex each chloride ion. Therefore, a mono-functional carboxylic acid molecule reacts with Choline Chloride, ChCl⁻, on a 1:2 molar basis as is the case with phenylpropionic acid (C₆H₆CH₂CH₂CO₂H) and phenylacetic acid (C₆H₆CH₂CO₂H).

Eutectics formed with di-functional carboxylic acids occur at a 50% mol ratio strongly suggesting a 1:1 complex between the acid and the chloride ion or else said acids act as bridging molecules between neighboring chloride ions. Such would be the case when considering oxalic acid (HO₂CCO₂H), malonic acid (HO₂CCH₂CO₂H) and succinic acid (HO₂CCH₂CH₂CO₂H), for examples.

The freezing point depression, when compared to an ideal mixture of the two components, for [ChCl⁻ oxalic acid] is 212° C. as compared to [ChCl⁻ (urea)₂] which was 178° C. but not as large as [ChCl⁻.(ZnCl₂)₂] systems 272° C., wherein covalent bonds are formed.

Eutectics formed with tris- or tri-functional carboxylic acids occur at a 30-35% mol acid. Eutectics containing citric and tricarballylic which exhibit the rheology of gels and are assumed to exhibit extensive bridging between acid groups and their neighboring chloride ions.

The melting point of eutectics formed by the reaction of 1 mol of choline chloride (ChCl⁻) and 1 mol of oxalic acid is 34° C.; 1 mol of ChCl⁻ and 1 mol of malonic acid is 10° C.; and 1 mol of ChCl⁻ and 1 mol of succinic acid is 71° C. The melting point of the choline chloride/citric acid eutectic is 69° C. and the choline'chloride/tricarballylic acid eutectic is 90° C.

### Example 9

### Dissolution of Cellulose with Ionic Liquids (Comparative Example)

In a typical procedure developed by Swatloski, et al. (U.S. Pat. No. 6,824,599), to prepare a 10 wt % solution, 0.5-1.0 grams of fibrous cellulose was placed in a glass vial and [C₄mim]Cl⁻ ionic liquid (10 grams) was added as a liquid at 70° C. (a temperature above its melting point). The vial was loosely capped, placed in a microwave oven and heated with 3-5 sec. pulses at full power. Between pulses, the vial was removed, shaken or vortexed and replaced in the oven. A clear, colorless, viscous solution was obtained. Although solutions containing 5-10 wt % cellulose are more easily prepared, solutions containing up to 25 wt % cellulose can be formed only as viscous pastes.

[C₄mim]Cl⁻ ionic liquids are comprised of [C₄mim]⁺ a 1-butyl-3-methylimidazolium cation and Cl⁻, a chloride ion. In comparing the chemicals employed, the highest cellulose solubility employing an ionic liquid and microwave heating is 25% and the product is a paste.

### Example 10

### Dissolution of Cellulose with Deep Eutectic Solvents (DES)

The dissolution of various cellulosic polymers including but not limited to xanthan gum, cellulose fibers, modified guar gum, carboxymethyl tamarind and sodium carboxymethyl cellulose were tested employing choline chloride.urea eutectics. To a small vial, a 50:50 mixture of the selected polymer and the eutectic solvent of choice was added and the sample placed into a standard convection oven at temperatures between 65-135° C. In all cases, the cellulosic polymer mentioned above were found to be soluble at the lowest temperature tested 65° C. (˜150° F.). When allowed to cool to room temperature, a clear, viscous solution or gel was found to have been formed.

Employing a choline chloride/urea deep eutectic solvent, 50 wt % solubility is not at all unreasonable, utilizing reasonable heating techniques. The resulting product at temperature is liquid.

Overview of SHIA of DES

Eutectic Solvent. According to this disclosure, a Deep Eutectic Solvent or solution (DES) may be formed by reacting an ammonium compound, for example N-(2-hydroxyethyl) trimethyl-ammonium chloride (choline chloride), with a hydrogen-bond donor (HBD) such as carboxylic acids, amines, amides and alcohols. These liquids have physical and solvent properties that are similar to ionic liquids formed from discrete ions and are easy to produce by simply reacting common commodity chemicals such as choline chloride and carboxylic acids or amides as further discussed hereinbelow.

Ammonium Compound Method I comprises providing a SHIA of eutectic solvent 100. Providing a SHIA of eutectic solvent 100 comprises selecting an ammonium compound 110 and reacting the ammonium compound 120 to produce a eutectic solvent. In applications, the ammonium compound is an ammonium halide. In embodiments, the ammonium compound is an ammonium chloride. In embodiments, the ammonium compound is ammonium chloride. In applications, the ammonium compound is a quaternary ammonium compound. In applications, the quaternary ammonium compound is selected from the group consisting of quaternary ammonium halides. In applications, the quaternary ammonium halide is selected from the group consisting of quaternary ammonium chlorides.

In embodiments, the ammonium compound is selected from the group consisting of the ammonium chlorides having the structure:

(R₁R₂R₃)—N⁺R₄—OHCl⁻ (6)

wherein R₁, R₂, R₃, and R₄ are each selected from the group consisting of H and CₓH_{y}, wherein 1≦x≦18 and 3≦y≦37. R₁, R₂, R₃ and R₄ can be branched or linear and can be alkyl, aryl or alkylaryl. In embodiments, R1, R2, R3, and R4 are not hydrogen, and the ammonium compound is a quaternized ammonium chloride having the structure as in Eq. (6). In embodiments, R₁, R₂, R₃, R₄ or any combination thereof is selected from the group consisting of methyl-, ethyl-, octadecyl-, phenyl, benzyl- and combinations thereof. In applications, R₁, R₂ and R₃ are methyl, and R₄ is ethyl. In this embodiment, the ammonium compound is the quaternary ammonium compound N-(2-hydroxyethyl) trimethyl-ammonium chloride (CH₃)₃—N⁺(CH₂CH₂OH)Cl⁻, also known as choline chloride or vitamin B4.

In embodiments, the ammonium compound is selected from the group consisting of ammonium chlorides having the structure:

(R₁R₂R₃)—N⁺—R₄Cl (7)

wherein R₁, R₂, R₃ and R₄ may be the same or different, and can be hydrogen or branched or linear alkyl, alkylaryl, or aryl groups. In applications, R₁, R₂, R₃ and R₄ are selected from the group consisting of H and CₓH_{y}, wherein 1≦x≦18 and 3≦y≦37. In applications, R₁, R₂ and R₃ are selected from the group consisting of methyl-, ethyl-, octadecyl-, phenyl, benzyl-, methoxy-, ethoxy-, and the like. In applications, R₁, R₂ and R₃ are methyl and R₄ is ethyl. In such an embodiment, the ammonium chloride may be the quaternary ammonium chloride 2-chloro-N,N,N-trimethylethanaminium. In embodiments, R₁, R₂, R₃, and R₄ are hydrogen, and the ammonium compound is ammonium chloride.

In embodiments, the ammonium compound is selected from the group consisting of chloro-substituted ammonium chlorides having the structure:

Cl⁻(R₁R₂R₃)—N⁺—R₄Cl (8)

wherein R₁, R₂, R₃ and R₄ may be the same or different, and can be hydrogen or branched or linear alkyl, alkylaryl, or aryl groups. In applications, R₁, R₂, R₃ and R₄ are selected from the group consisting of methyl-, ethyl-, octadecyl-, phenyl, benzyl-, methoxy-, ethoxy-, and the like. In applications, R₁, R₂ and R₃ are methyl groups and R₄ is an ethyl group. In this embodiment, the ammonium compound is the quaternary ammonium chloride chlorcholine chloride, [2-chloroethyl-trimethyl-azanium chloride, Cl⁻(CH₃)₃N⁺CH₂CH₂Cl].

In embodiments, the ammonium compound is selected from the group consisting of ammonium chloride, choline chloride [N-(2-Hydroxyethyl) trimethyl ammonium chloride, (CH₃)₃—N⁺—CH₂CH₂OHCl], chlorcholine chloride, and 2-chloro-N,N,N-trimethylethanaminium. In embodiments, the ammonium compound is a quaternary ammonium compound selected from the group consisting of chlorcholine chloride, choline chloride, 2-chloro-N,N,N-trimethylethanaminium, and combinations thereof.

Second Compound Reacting the ammonium compound to produce a eutectic solvent at 120 comprises reacting the ammonium compound with a second compound to produce a deep eutectic solvent. The second compound is a hydrogen bond donor (HBD). In applications, the second compound is selected from amines (including diamines), amides, carboxylic acids, alcohols and metal halides. In applications, the second compound has a chain length (C_{length}) in the range of from 1 to 18; from 1 to 10; from 1 to 8; from 2 to 6.

In applications, the second compound is an amine. In applications, the second compound is selected from di-functional amines. In applications, the second compound is selected from the group consisting of compounds with the structure:

R₁—(CH₂)ₓ—R₂, (9)

wherein R₁ and R₂ are —NH₂, —NHR₃, or —NR₃R₄ and 2≦x≦6. In applications, the di-functional amine compound is ethylene diamine, H₂N—(CH₂)₂—NH₂.

In applications, the second compound is an amide. In applications, the second compound is selected from the group consisting of compounds with the structure:

R—CO—NH₂, (10)

wherein R is H, NH₂, CH₃, or CF₃. In applications, R is NH₂, and the compound is urea, H₂N—CO—NH₂. In applications, the second compound is selected from 1-methyl urea, (CH₃NHCONH₂), 1,3-dimethylurea (CH₃NHCONHCH₃), thiourea ((NH₂)₂CS), and acetamide (CH₃CONH).

In specific embodiments, the deep eutectic solvent (DES) is a solvents/solution of a di-functional amine and N-(2-hydroxyethyl) trimethyl-ammonium chloride, generically choline chloride.

As discussed further in Examples 12 and 13 hereinbelow, reacting the ammonium compound may comprise combining the ammonium compound with an amide (e.g., urea) at a 1:2 mol ratio. The mixture is heated, with stirring, and allowed to react until a clear, viscous, uniform solution is formed. The mixture may be heated to a temperature greater than 70° C., greater than 90° C. but not greater than 100° C. The liquid is then allowed to cool to room temperature. Cooling to room temperature may comprise cooling at a rate of less than 1° C./min.

In applications, the second compound is selected from carboxylic acids. In applications, the second compound is selected from mono- and di-functional organic alkyl and aryl acids. In applications, the second compound is a mono-functional carboxylic acid. In embodiments, the ammonium compound is reacted with the mono-carboxylic acid at a 1:2 molar ratio of ammonium compound to mono-functional carboxylic acid to form the eutectic solvent. In applications, the mono-carboxylic acid is selected from phenylpropionic acid (C₆H₆CH₂CH₂CO₂H), phenylacetic acid (C₆H₆CH₂CO₂H), and combinations thereof.

In applications, the second compound is a di-functional carboxylic acid. As discussed in Example 14 hereinbelow, in such embodiments, the ammonium compound may be reacted with the di-functional carboxylic acid at a 1:1 molar ratio. In applications, the second compound is selected from oxalic acid (HO₂CCO₂H), malonic acid (HO₂CCH₂CO₂H), succinic acid (HO₂CCH₂CH₂CO₂H), and combinations thereof.

In embodiments, the second compound is selected from tris or tri-functional carboxylic acids. In such embodiments, the solvent may be formed at a 30-35 mol % acid. Suitable tri-functional carboxylic acids include citric acid and tricarballylic acid.

In applications, the second compound is a metal halide. The metal halide may be selected from the group consisting of aluminum chloride, zinc chloride, tin chloride, iron chloride, and combinations thereof. The latter three molten product salts have the advantage that they are not water sensitive, although they are found to be, in general, more viscous than the aluminum derivative. The depression of the freezing points may be as much as 190° C.

Reacting Ammonium Compound with Second Compound As discussed further in Examples 12 and 13 hereinbelow, reacting the ammonium compound may comprise combining the ammonium compound (e.g., quaternary ammonium halide) with an amide (e.g., urea) at a 67 mol percent amide; with a mono-functional carboxylic acid at a 67 mol percent mono-functional carboxylic acid; with a di-functional carboxylic acid at 50 mol percent di-functional carboxylic acid; with a tri-carboxylic acid at 30-35 mol percent; or with metal halide at a 30-67 mol percent metal halide, depending upon the charge on the metal halide. For example, ZnCl₂ reacts in a different ratio than FeCl₃. In the specific case of ZnCl₂ the reaction yields [(CHCl)(ZnCl₂)₂] which reflects a reaction ratio of 1:2 or 67 mol percent metal or zinc chloride.

The mixture comprising the ammonium compound and second compound may be heated, with stirring, and allowed to react until a clear, viscous, uniform solution is formed. The mixture may be heated to a temperature greater than 70° C., greater than 90° C. but not greater than 100° C. The liquid is then allowed to cool to room temperature. Cooling to room temperature may comprise cooling at a rate of less than 1° C./min.

Introducing the Drilling Fluid into Subterranean Formation.

Once formed, the method further comprises introducing drilling fluid into a subterranean formation 200, such as a wellbore, casing, fracture or face of a formation. The subterranean formation may contain therein swellable clays. As such, DES may be introduced into the subterranean formation, whereby in various applications, the DES may be introduced into the subterranean formation as a component of the drilling fluid (i.e., a fracturing fluid, drilling mud, or other drilling fluid). In this manner, the DES is utilized as an additive to the drilling fluid.

The drilling fluid with DES may be introduced into the subterranean formation at conditions known to those of skill in the art to be suitable for the introduction of fluids downhole. In applications, the DES may be introduced into the subterranean formation at a temperature in the range of from about 50° C. to about 150° C. Alternatively, a temperature in the range of from about 65° C. to about 135° C. In applications, the drilling fluid with the DES may be pumped into the subterranean formation at a pressure in the range of from about 500 to about 25,000 psig. Alternatively, a pressure in the range of from about 1,000 to about 10,000 psig. Alternatively, a pressure in the range of from about 1,000 to about 5,000 psig.

Introducing Post-Treatment Solution into Subterranean Formation.

The method I may further comprise introducing post-treatment solution into the subterranean formation 300. In instances, the DES is used alone, with no post-treatment. In applications, the DES may be used and a wash may be subsequently introduced into the subterranean formation. The wash may be selected from a water wash, a caustic wash, an anhydride wash, an acid wash, or a combination thereof. A caustic wash may be selected from sodium hydroxide and potassium hydroxide. An anhydride wash may comprise acetic anhydride.

While the preferred embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

To further illustrate various illustrative embodiments of the present invention, the following examples are provided.

### Examples

### Example 12

### Synthesis of Choline Chloride/Amide Deep Eutectic Solvent (DES)

Urea which has a melting point of 133° C. (271° F.) is combined with N-(2-hydroxyethyl) trimethyl-ammonium chloride (choline chloride) which has a melting point of 302° C. (575° F.) in a 2:1 molar ratio. One (1) mol (139.6 grams) of choline chloride, [N-(2-hydroxyethyl) trimethylammonium chloride, (CH₃)₃N⁺CH₂CH₂OH]Cl⁻, FW=139.6 g/mol] is employed as a dry powder or flake and is added to 2 mols of urea, an amide, [120 grams [(NH₂)₂CO, FW=60 g/mol]. With stirring, the dry mixture is heated to 80° C. (176° F.) until the solids have all been dissolved to affect a reaction. The reaction is continued until a clear, viscous, uniform solution is formed. The liquid is then allowed to cool to room temperature at a rate no faster than 1° C./min. The yield is quantitative and the product has a melting point of 12° C. (−53.6° F.). The variables for this deep eutectic solvent are: P=7.63×10⁻³; η_{calc}=11cP; Vₘ=210.1 cm³mol¹; V_{free}=9.1%; and E_{η}=58 kJmol⁻¹.

Numerous other choline chloride (ChCl⁻)/amide compounds can be synthetically prepared employing the method detailed above including but not limited to 1-methyl urea (CH₃NHCONH₂, m. p.=29° C.), 1,3-dimethylurea (CH₃NHCONHCH₃, m.p.=70° C.), thiourea ((NH₂)₂CS, m.p.=69.° C.), acetamide (CH₃CONH₂, m.p.=51° C.) and others.

### Example 13

### Synthesis of Chlorcholine Chloride/Amide Deep Eutectic Mixtures (DES)

Chlorcholine chloride [Cl⁻(CH₃)₃N⁺CH₂CH₂Cl), 12.96 g, 0.082 mol) is added to urea (9.78 g, 0.163 mol) and the mixture heated to 80° C. (176° F.) with stirring for approximately 30 minutes. A clear, viscous, uniform solution is formed and allowed to cool to room temperature at a rate of approximately 1° C./min. The liquid can be maintained for at least a month when protected against moisture.

As with choline chloride in Example 12, numerous chlorcholine chloride/amide derivatives can be prepared. The reaction time is reduced due to the higher reactivity coefficient of the chloro-derivative selected.

### Example 14

### Synthesis of Choline Chloride/Carboxylic Acid Deep Eutectic Mixtures (DES)

Based on the method presented in Example 13, it becomes apparent that a eutectic is formed at a composition of 67% mol urea. From this data, it can be inferred that to form the eutectic two carboxylic acid molecules are required to complex each chloride ion. Therefore, a mono-functional carboxylic acid molecule reacts with ChCl⁻ on a 1:2 molar basis as is the case with phenylpropionic acid (C₆H₆CH₂CH₂CO₂H) and phenylacetic acid (C₆H₆CH₂CO₂H).

Eutectics formed with di-functional carboxylic acids occur at a 50% mol ratio strongly suggesting a 1:1 complex between the acid and the chloride ion or else said acids act as bridging molecules between neighboring chloride ions. Such would be the case when considering oxalic ac id (HO₂CCO₂H), malonic ac id (HO₂CCH₂CO₂H) and succinic ac id (HO₂CCH₂CH₂CO₂H), for examples.

The freezing point depression, when compared to an ideal mixture of the two components, for [ChCl⁻.oxalic acid] is 212° C. as compared to [ChCl⁻(urea)₂] which was 178° C. but not as large as [ChCl⁻.(ZnCl₂)₂] systems 272° C., wherein covalent bonds are formed.

Eutectics formed with tris- or tri-functional carboxylic acids occur at a 30-35% mol acid. Eutectics containing citric and tricarballylic which exhibit the rheology of gels and are assumed to exhibit extensive bridging between acid groups and their neighboring chloride ions.

The melting point of eutectics formed by the reaction of 1 mol of choline chloride (ChCl⁻) and 1 mol of oxalic acid is 34° C.; 1 mol of ChCl⁻ and 1 mol of malonic acid is 10° C.; and 1 mol of ChCl⁻ and 1 mol of succinic acid is 71° C. The melting point of the choline chloride/citric acid eutectic is 69° C. and the choline chloride/tricarballylic acid eutectic is 90° C.

### Example 15

In an effort to synthesize DES-based SHIAs, choline chloride and certain diamines were reacted such that the diamines contained two, four and six carbons respectively. Solid choline chloride, N-(2-hydroxyethyl) trimethyl ammonium chloride (13.95 g, 0.1 mol) is added to a reaction flask equipped with a stirrer, a heating mantle and an air condenser containing 6.0 g (0.1 mols) of ethylene diamine (H₂N—CH₂—CH₂—NH₂) and the temperature is increased to 70° C. for a minimum of 20 minutes to an hour. After this time the reaction mixture is allowed to cool and the melting point of the deep eutectic solvent formed was determined to be 29° C. (84° F.) which was consistent with the results reported by Abbott in US 2004/0097755 A1.

### Example 16

The reaction according to the procedure in Example 15 was repeated wherein 13.95 g (0.1 mol) of choline chloride was reacted with 8.8 g (0.1 mols) of 1,4-butane diamine (H2N—CH₂—CH₂—CH₂—CH₂—NH₂) The reaction did not appear to proceed at 70° C. so the temperature was raised to 85° C. at which point the reaction proceeded yielding a semi-solid, water-soluble compound.

### Example 17

The reaction according to the procedure in Example 15 was repeated wherein 13.95 g (0.1 mol) of choline chloride was reacted with 11.6 g (0.1 mols) of 1,6-hexane diamine (H2N—CH₂—CH₂—CH₂—CH₂—CH₂—CH₂—NH₂). The reaction did not appear to proceed at 70° C. so the temperature was again raised to 85° C. at which point the reaction proceeded yielding a semi-solid, water-soluble compound.

### Example 18

In an effort to produce higher DES, 30.7 g (0.1 mol) of hydroxypropyl bis-hydroxyethyldimonium chloride, a diquaternary compound available from Colonial Chemical, South Pittsburg, Tenn., having the tradename COLA® MOIST 200 was reacted with 12 g (0.2 mols) of ethylene diamine. The reaction appeared to proceed at 70° C. yielding a clear, water-soluble, slightly viscous compound.

### Example 19

The reaction according to the procedure in Example 18 was repeated wherein 72.8 g (0.1 mol) of polyquaternium-71, a tetraquaternary compound available from Colonial Chemical, South Pittsburg, Tenn. having the tradename COLA® MOIST 300P was reacted with 24 g (0.4 mols) of ethylene diamine. The reaction appeared to proceed at 70° C. yielding a clear, water-soluble, slightly viscous compound.

### Example 20

The following test was conducted to demonstrate the maximum amount of API bentonite that can be inhibited by a single 10 pound per barrel (ppb) treatment of a DES versus a state-of-the-art amine treating compound D-230 as received from Huntsman Corporation and investigated by Patel et al., U.S. Pat. No. 6,857,485. The procedure disclosed was used in Example 1 and Examples 2-4.

Blank

| | lbs. per barrel Bentonite | | | | | | | | |
|---|---|---|---|---|---|---|---|---|---|
| Viscosity Readings(rpm) | 20 | 30 | 40 | 50 | 60 | 70 | 80 | PV | YP |
| 600 | | 59 | 83 | F | | | | 20 | 19 |
| 300 | | 39 | 54 | F | | | | 29 | 25 |
| | lbs. per barrel Bentonite treated with D-230 | | | | | | | | |
| 600 | 4 | 4 | 6 | 7 | 8 | 9 | 13 | | |
| 300 | 2 | 3 | 3 | 3 | 4 | 5 | 8 | 5 | 3 |
| | lbs. per barrel Bentonite treated with the DES of Example 17 | | | | | | | | |
| 600 | | | 3 | 4 | | | 25 | | |
| 300 | | | 2 | 2.5 | | | 13 | 12 | 1 |
| | lbs. per barrel Bentonite treated with the DES of Example 16 | | | | | | | | |
| 600 | | 6 | | 8.5 | | | 26 | | |
| 300 | | 2 | | 4 | | | 14 | 12 | 2 |
| | lbs. per barrel Bentonite treated with the DES of Example 15 | | | | | | | | |
| 600 | | 8 | | 21 | | | 43 | | |
| 300 | | 3 | | 12.5 | | | 26 | 17 | 9 |

In embodiments, DES as disclosed herein may be used in a drilling fluid at a concentration of from about 1 to about 20 pounds per barrel (lbs/bbl or ppb), alternatively from about 2 to about 18 ppb, alternatively from about 2 to about 12 ppb. In embodiments, DES may be generally soluble in aqueous drilling fluids. Acid treatment of DES prior to introduction into drilling fluids may increase DES solubility in aqueous drilling fluids.

In some embodiments, the DES as SHIA in a water-based drilling fluid composition, before being introduced into the drilling fluid composition, may be pretreated with an acid such that the pH is adjusted to be in the range of 6.0-10.0, alternatively in the range of 6.5-9.5, alternatively in the range of 7.0-9.0. Suitable acids for this pretreatment include mineral acids and organic acids. Examples of mineral acids are hydrochloric acid (HCl), sulfuric acid (H₂SO₄), nitric acid (HNO₃), and phosphoric acid (H₃PO₄) Examples of organic acids are carbonic acid, formic acid, acetic acid, propionic acid, and benzoic acid. In some cases, acid treatment increases the solubility of these SHIAs in aqueous drilling fluid compositions. In some cases, acid treatment causes these SHIAs to be less volatile and reduces the smell of these SHIAs. In some cases, acid treatment improves the handling properties of SHIAs so that workers will deal with a relatively pH neutral composition. In embodiments, the DES as disclosed herein as the SHIA in a water-based drilling fluid composition may not hydrolyze in the presence of water. Furthermore, the DES may be stable and not hydrolyzed at a temperature in the range of from about 100° F. to about 500° F., alternatively from about 150° F. to about 400° F., alternatively from about 150° F. to about 300° F.

While the preferred embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

### REFERENCES

“Surfactants for Oilfield Operations” a seminar sponsored by Huntsman Corporation, September 2001.
“The Use of SURFONAMINE® Amines in Ink and Pigment Applications”, Technical Bulletin, Huntsman Corporation, www.huntsman.com.
“Teric™ and Ecoteric™ Fatty Acid Ethoxylates”, Surfactants@ Huntsman.com.
“pKa Data Compiled by R. Williams”, website.
“Ethyleneamines”, published online by the Dow Chemical Company, 2001.
“Amines-Amination & Reductive Amination”, published online by BASF, http://www2.basf de/de/intermed/nbd/technology/amination.htm.
“N-aminopropylmorpholine (APM)” Technical Bulletin, Huntsman Corporation, www.huntsman.com.
“Dimethylaminopropylamine (DMAPA)”, Technical Bulletin, Huntsman Corporation, www.huntsman.com.
“Methoxypropylamine (MOPA)”, Technical Bulletin, Huntsman Corporation, www.huntsman.com.
Tomalia, et al., “A New Class of Polymers: Starburst-Dendritic Macromolecules”, Polym. J., 17(1):117-132 (1985).
Tomalia, et al., “Starburst Dendrimers: Molecular-Level Control of Size, Shape, Surface Chemistry, Topology and Flexibility from Atoms to Macroscopic Matter”, Angew. Chem. Int. Ed. Engl., 29:138-175 (1990).
De Brabander-van den Berg, E. M. M. and Meijer, E. W., “Poly (propylene imine) Dendrimers: Large-Scale Synthesis by Heterogeneously Catalyzed Hydrogenations”, Angew. Chem. Int. Ed. Engl., 32(9): 1308-1311 (1993).
Issherner, et al., “Dendrimers: From Generations and Functional Groups to Functions”, Angew. Chem. Int. Ed. Engl., 33: 2413-2420 (1995).
Bosman, et al., “About Dendrimers: Structure, Physical Properties and Applications, Chem. Rev., 99:1665-1688 (1999).
Gupta et al., “Polypropylene Imine Dendrimer Mediated Solubility Enhancement: Effect of pH and Functional Groups of Hydrophobes”, J. Pharm. Pharmaceut. Sci., 10(3): 358-367 (2007).

### Patent References:

| | | |
|---|---|---|
| 4,820,511 | April 1989 | Hoeffkes, et al. |
| 4,828,724 | May 1989 | Davidson |
| 4,828,726 | May 1989 | Himes et al. |
| 4,842,073 | June 1989 | Himes at al. |
| 4,847,342 | July 1989 | Pfeiffer |
| 4,889,645 | December 1989 | Firth, Jr. |
| 4,913,585 | April 1990 | Thompson et al. |
| 4,940,764 | July 1990 | Meister |
| 4,990,270 | February 1991 | Meister |
| 5,026,490 | June 1991 | Pfeiffer et al. |
| 5,066,753 | November 1991 | Pfeiffer |
| 5,089,151 | February 1992 | Hall et al. |
| 5,097,904 | March 1992 | Himes |
| 5,099,923 | March 1992 | Aften et al. |
| 5,211,250 | May 1993 | Kubena, Jr., et al. |
| 5,330,622 | July 1994 | Honnorat et al. |
| 5,350,740 | September 1994 | Patel et al. |
| 5,380,706 | January 1995 | Himes et al. |
| 5,424,284 | June 1995 | Patel et al. |
| 5,558,171 | September 1996 | McGlothlin et al. |
| 5,593,952 | January 1997 | Jarrett |
| 5,771,971 | June 1998 | Horton et al. |
| 5,908,814 | June 1999 | Patel et al. |
| 6,247,543 | June 2001 | Patel et al. |
| 6,484,821 | November 2002 | Patel et al. |
| 6,609,578 | August 2003 | Patel et al. |
| 6,831,043 | December 2004 | Patel et al. |
| 6,857,485 | February 2005 | Patel et al. |
| 7,250,930 | July 2007 | Patel et al. |
| 4,216,171 | August 1980 | Soula et al. |
| 4,289,872 | September 1981 | Denkewalter et al. |
| 4,410,688 | October 1983 | Denkewalter et al. |
| 4,507,466 | March 1985 | Tomalia et al. |
| 4,558,120 | December 1985 | Tomalia et al. |
| 4,568,737 | February 1986 | Tomalia et al. |
| 4,587,329 | May 1986 | Tomalia et al. |
| 4,599,400 | July 1986 | Tomalia et al. |
| 4,631,337 | December 1986 | Tomalia et al. |
| 4,690,985 | September 1987 | Tomalia et al. |
| 4,737,550 | April 1988 | Tomalia et al. |
| 4,845,297 | July 1989 | Kumoi et al. |
| 4,857,599 | August 1989 | Tomalia et al. |
| 5,041,516 | August 1991 | Frechet et al. |
| 5,418,301 | May 1995 | Hult et al. |
| 5,530,092 | June 1996 | Meijer et al. |
| 5,610,268 | March 1997 | Meijer et al. |
| 5,698,662 | December 1997 | Stoelwinder et al. |
| 5,705,602 | January 1998 | Kawashima et al. |

The discussion of a reference in the Description of the Related Art is not an admission that it is prior art to the present invention, especially any reference that may have a publication date after the priority date of this application. The disclosures of all patents, patent applications, and publications cited herein are hereby incorporated herein by reference in their entirety, to the extent that they provide exemplary, procedural, or other details supplementary to those set forth herein.

What is claimed is:

1. A method of using water-based drilling fluid in a subterranean formation containing a shale which swells in the presence of water, the method comprising:
providing the water-based drilling fluid, wherein the drilling fluid comprises:
an aqueous based continuous phase;
a weighting material; and
a shale hydration inhibition agent (SHIA) comprising Deep Eutectic Solvents (DES) formed by the reaction of:
(a) a first compound comprising an ammonium compound, and
(b) a second compound comprising at least one of amides, amines, diamines, cyclic amines, cyclic diamines, and combinations thereof; and
circulating the drilling fluid into the subterranean formation, wherein the SHIA is present in a sufficient amount to reduce shale swelling.

2. The method of claim 1, wherein the ammonium compound comprises a quaternary ammonium compound.

3. The method of claim 2, wherein the quaternary ammonium compound comprises at least one of choline chloride, chlorcholine chloride, and combinations thereof.

4. The method of claim 3, wherein the second compound consists of amines and diamines having a chain length (C_{length}) of 2≦C_{length}≦6.

5. The method of claim 2, wherein the second compound consists substantially of diamine, and wherein the diamine is selected from the group ethylene diamine, H₂N—(CH₂)₂—NH₂, 1,4-butane diamine, H₂N—(CH₂)₄—NH₂, and 1,6-hexane diamine, H₂N—(CH₂)₆—NH₂.

6. The method of claim 1, wherein the drilling fluid further comprises at least one of a fluid loss control agent, an encapsulation additive, a corrosion inhibitor, and combinations thereof.

7. The method of claim 1 further comprising introducing one or more wash solution into the subterranean formation following circulating the drilling fluid into the subterranean formation, wherein the one or more wash solution is selected from the group consisting of caustic solutions, acid solutions, anhydride solutions, water, and combinations thereof.

8. The method of claim 1, wherein the DES is reacted with at least one of a group selected from mineral acids, lower organic acids, and lower organic diacids, and wherein the DES is further used to provide a formulation to react with downhole scale comprising at least one of calcium, barium, and combinations thereof.

9. The method of claim 8, wherein the aqueous based continuous phase is selected from the group consisting of fresh water, sea water, brine, mixtures of water and water soluble organic compounds, and combinations thereof, and wherein the weighting material is selected from the group consisting of barite, hematite, iron oxide, calcium carbonate, magnesium carbonate, organic and inorganic salts, and combinations thereof.

10. A method of reducing shale swelling encountered during the drilling of a subterranean well, the method comprising:
providing a water-based drilling fluid comprising an aqueous based continuous phase, a weighting material, and a SHIA comprising Deep Eutectic Solvents (DES) formed by the reaction of (a) a quaternary ammonium compound, and (b) a diamine having a chain length (C_{length}) of 2≦C_{length}≦6; and
circulating the drilling fluid into the subterranean well, wherein the SHIA is present in a sufficient amount to reduce shale swelling.

11. The method of claim 10, wherein the aqueous based continuous phase is selected from the group consisting of fresh water, sea water, brine, mixtures of water and water soluble organic compounds, and combinations thereof.

12. The method of claim 11, wherein the weighting material is selected from the group consisting of barite, hematite, iron oxide, calcium carbonate, magnesium carbonate, benzoic acid, organic and inorganic salts, and combinations thereof.

13. The method of claim 12 further comprising treating the SHIA with a mineral acid or an organic acid prior to providing the SHIA with the drilling fluid.

14. The method of claim 13, wherein the acid is selected from the group consisting of hydrochloric acid (HCl), sulfuric acid (H₂SO₄), nitric acid (HNO₃), phosphoric acid (H₃PO₄), carbonic acid, formic acid, acetic acid, propionic acid, benzoic acid, and combinations thereof.

15. The method of claim 10, wherein the quaternary ammonium compound comprises at least one of choline chloride, chlorcholine chloride, and combinations thereof, and wherein the diamine is selected from the group ethylene diamine, H₂N—(CH₂)₂—NH₂, 1,4-butane diamine, H₂N—(CH₂)₄—NH₂, and 1,6-hexane diamine, H₂N—(CH₂)₆—NH₂.

16. A method of treating a subterranean formation, the method comprising:
providing a quaternary ammonium compound;
reacting the quaternary ammonium compound with a diamine to form a DES;
introducing the formed DES into a drilling fluid; and
circulating the drilling fluid into the subterranean formation in order to treat the formation.

17. The method of claim 16, wherein the formed DES comprises a mixing temperature of greater than 65° C.

18. The method of claim 16, wherein the quaternary ammonium compound comprises at least one of choline chloride, chlorcholine chloride, and combinations thereof, and wherein the diamine is selected from the group ethylene diamine, H₂N—(CH₂)₂—NH₂, 1,4-butane diamine, H₂N—(CH₂)₄—NH₂, and 1,6-hexane diamine, H₂N—(CH₂)₆—NH₂

19. The method of claim 18 further comprising treating the DES with a mineral acid or an organic acid prior to introducing the DES into the drilling fluid.

20. The method of claim 19, wherein the acid is selected from the group consisting of hydrochloric acid (HCl), sulfuric acid (H₂SO₄), nitric acid (HNO₃), phosphoric acid (H₃PO₄), carbonic acid, formic acid, acetic acid, propionic acid, benzoic acid, and combinations thereof.
